(19) United States
(12) Patent Application Publication
(10) Pub. No.: US 2026/0022964 A1
(43) Pub. Date: Jan. 22, 2026

(54) ASSEMBLY, USE OF AN ASSEMBLY, AND METHOD FOR ASCERTAINING AT LEAST ONE PARAMETER

(71) Applicant: DEUTSCHES ZENTRUM FÜR LUFT- UND RAUMFAHRT E.V., 53227 Bonn (DE)

(72) Inventors: Niklas BLUM, Almeria (ES); Stefan WILBERT, Almeria (ES); Bijan NOURI, Almeria (ES)

(73) Assignee: DEUTSCHES ZENTRUM FÜR LUFT- UND RAUMFAHRT E.V., 53227 Bonn (DE)

(21) Appl. No.: 18/997,576

(22) PCT Filed: Nov. 8, 2023
(86) PCT No.: PCT/EP2023/081145

§ 371 Date: Jan. 22, 2025

(30) Foreign Application Priority Data
Nov. 10, 2022 (DE) 10 2022 129 771.3

(51) Int. Cl. G01J 1/42; G01W 1/12

(52) U.S. Cl. CPC G01J 1/42; G01W 1/12; G01J 2001/4285

(57) ABSTRACT

An arrangement for ascertaining at least one parameter for determining components of a global irradiance includes an evaluation and control device and a camera assembly having at least one camera, wherein the at least one camera is fixed at a predetermined distance from an earth surface at least while ascertaining the parameter, wherein the camera assembly is designed to capture camera data in a spatial field of view of approximately 360° around the camera assembly, wherein the camera data is suitable for deriving information concerning solar radiation and/or on the position and/or properties of clouds. A method of use of such an assembly, a method for ascertaining at least one parameter for determining at least one component of global irradiance, and a computer program are also provided.

### BACKGROUND AND SUMMARY

The invention relates to an assembly for ascertaining at least one parameter for determining at least one component of a global irradiance, a use of an assembly for ascertaining at least one parameter for determining at least one component of a global irradiance, and a method for ascertaining at least one parameter for determining at least one component of a global irradiance.

Cloud cameras and shadow cameras as well as corresponding assemblies and their application are among others known from the article Kuhn, P. et al. “Benchmarking three low-cost, low-maintenance cloud height measurement systems and ECMWF cloud heights against a ceilometer,” Solar Energy, Vol. 168, 2018, pp. 140-152, DOI: 10.1016/j.solener.2018.02.050. It describes a multi-camera assembly in which a camera has a field of view oriented towards the sky and is able to record camera data from the sky. A shadow camera disposed several hundred meters away can record camera data of the earth.

Cloud camera assemblies can be used for automated detection of a degree of cloud cover in a sky and for shortest-term predictions of solar radiation, e.g. for more efficient operation of power supply systems consisting of solar panels and diesel aggregates or battery storage units.

These cloud-camera-based prediction systems typically detect clouds in the camera images. The height and velocity of the clouds and therefore the future position of the clouds can be determined using the data of at least one second cloud camera. A forecast for the shading of specific areas can be made from the cloud position.

Shadow camera assemblies are usually installed on tall towers or mountain ridges overlooking the monitored area. Shadow cameras can be used to create high-resolution maps of solar radiation around the point of installation of the shadow cameras. Shadow cameras having a rather narrow viewing angle are used. By comparing the position of cloud shadows in images between different time stamps, these systems can determine the velocity of clouds above the ground.

Solar power plant monitoring systems or solar resource measurement systems at the planned location of a solar power plant are often equipped with pyranometers oriented towards the sky and, in some cases, with pyranometers oriented towards the ground to measure the radiation from the sky or the radiation reflected from the ground. These measurements are used to evaluate the performance of a solar power plant or to assess the solar resource at the location.

The publication titles “Shadow camera system for the generation of solar irradiance maps”, Solar Energy, 157, 2017, 157-170. DOI: 10.1016/j.solener.2017.05.074 reveals an assembly with multiple cameras, wherein the camera assembly consisting of six cameras takes images of the ground from a high tower.

It is desirable to provide a cost-effective assembly for ascertaining at least one parameter for determining at least one component of a global irradiance, wherein the measurement setup is located in one place.

It is desirable to provide a use of such an assembly for ascertaining at least one parameter for determining at least one component of a global irradiance, which ascertains one or more parameters cost-effectively and/or reliably.

It is desirable to provide a method for ascertaining at least one parameter for determining at least one component of a global irradiance, which determines the at least one parameter cost-effectively and/or reliably.

The present invention can facilitate various advantages.

The following definitions apply to the inventive assembly for ascertaining at least one parameter for determining at least one component of a global irradiance, the inventive use of the assembly, and the inventive method for ascertaining at least one parameter.

In the following, an evaluation and control device is understood to be a physical module or a logical group of interacting hardware and/or software components or a processor. The evaluation and control device comprises at least one signal input for receiving camera data and at least one signal output for outputting measurement results and/or camera data.

At least one computing unit can evaluate the camera data received by means of a corresponding programming and calculate at least one parameter and/or other measurement results. Multiple computing units can be provided, each of which performs single or multiple process steps and/or single or multiple evaluation steps. Additionally or alternatively, multiple computing units can be used to ascertain or determine one or more parameters. These computing units or further computing units can determine one or more components of the global irradiance. The calculations and/or determinations and/or ascertainments can be performed centrally in one place or decentralized in different locations. At least one storage unit can store intermediate and/or final results and/or ascertained values of the parameters and/or at least one component of the global irradiance.

The camera data can be sent via a cable or wirelessly to the signal input or from the signal output. In the case of the invention and the inventive use of the assembly, one evaluation and control device or multiple evaluation and control devices can be involved in the evaluation and calculation. The evaluation can additionally or alternatively at least partially be implemented on a server. The evaluation can be performed with a computer program designed to perform the calculation steps. Similarly, a computer program product can be provided on which a computer program is stored that is designed to perform the calculation steps.

The evaluation and control device can be understood as a physical module. However, the evaluation and control device could also easily be implemented on a server. Then this module is a computer program and not physically present. The evaluation and control device can take data from a cloud or store it in a cloud.

A camera assembly can be understood as a camera assembly, which comprises a camera which captures a spatial field of view of 360° or at least approximately 360° around the camera assembly. Alternatively, the camera assembly can comprise multiple cameras which together capture the spatial field of view of at least approximately 360° around the camera assembly. The camera assembly can have a first camera and a second camera.

The spatial field of view of at least approximately 360° around the camera assembly is conveniently composed of a first partial spatial field of view and a second partial spatial field of view of at least 180° or at least approximately 180° each around the camera assembly. The partial fields of view can be disposed along a common axis, in particular the common axis can be oriented substantially in a vertical direction, or the common axis can be oriented at a tilt angle to the vertical direction.

The spatial field of view of at least approximately 360° can conveniently be a three-dimensional field of view. The partial spatial field of view of at least approximately 180° can be a three-dimensional partial field of view.

The camera assembly can have the common axis. The common axis can extend through the camera or through the multiple cameras of the camera assembly. The common axis can substantially be oriented in the vertical direction, forming a substantially vertical axis, or tilted towards the vertical direction at a tilt angle, forming an oblique axis.

Alternatively, each of the cameras can be disposed on a separate axis. These cameras can substantially be parallel to one another or tilted against one another.

The camera looking down can conveniently capture the ground below the camera looking up. The cameras can be disposed in a common holding assembly or in separate holding assemblies.

The one or more axes can substantially be oriented in a vertical direction. Alternatively, the one or more axes can be oriented at a tilt angle to a vertical direction.

A small distance between the axes makes it possible for both cameras to always be shaded by clouds moving through at approximately the same time. A small distance between the axes of a few meters, in particular of a maximum of about 10 m, is advantageous.

In addition, a field of view of at least approximately 360° can only be reconstructed from the partial fields of view of the cameras with sufficient accuracy if the two cameras are disposed at a small distance from each other. For this purpose, a distance of not more than about 10 meters should not be exceeded. This prevents the cloud shadows in the image of the camera looking towards the ground from no longer corresponding with the clouds in the image of the camera looking towards the sky with sufficient precision if the distance is too long. This effect can be relevant, in particular, at very low clouds at a few hundred meters.

The spatial field of view of at least approximately 360° around the camera assembly can extend in two opposite directions and, in total, realize the spatial field of view of at least approximately 360°.

If the camera assembly has multiple cameras, the first camera and the second camera can form the common axis, wherein the common axis is substantially vertical and capable of forming a substantially vertical axis, or the axis can be tilted towards the vertical axis at a tilt angle capable of forming the oblique axis.

If the cameras are disposed on a common axis, the field of view of the first camera can extend upwards along the common axis, and the field of view of the second camera can extend downwards along the common axis. Alternatively, the partial fields of view can extend along multiple axes, in particular two axes. These axes can substantially be parallel to one another or tilted against one another. The one or more axes can substantially be oriented in a vertical direction. Alternatively, the one or more axes can be oriented at a tilt angle to a vertical direction.

In particular, the one or more axes can be arranged such that the camera looking down can capture the ground below the camera looking up.

The two axes are advantageously disposed at a small distance from one another. A small distance between the axes makes it possible for both cameras to always be shaded by clouds moving through at approximately the same time. A small distance between the axes of a few meters, in particular of a maximum of about 10 m, is advantageous.

In addition, a field of view of at least approximately 360° can only be reconstructed from the partial fields of view of the cameras with sufficient accuracy if the two cameras are disposed at a small distance from one another. For this purpose, a distance of not more than about 10 meters should not be exceeded. This prevents the cloud shadows in the image of the camera looking towards the ground from no longer corresponding with the clouds in the image of the camera looking towards the sky with sufficient precision if the distance is too long. This effect can be relevant, in particular, at very low clouds at a few hundred meters.

Thus, with two cameras disposed along the same common axis, the spatial field of view of at least approximately 360° can be formed by a partial spatial field of view of at least approximately 180° each, which forms the spatial field of view of approximately 360°. The spatial partial field of view of at least approximately 180° each forms a hemispherical or at least approximately hemispherical field of view.

A spherical field of view of at least approximately 360° around the camera assembly is understood in the following to be a spherical field of view or at least an approximately spherical field of view around a center.

In the following, a hemispherical shape is understood to include an at least approximately hemispherical shape. Likewise, a spherical shape is understood to include an at least approximately spherical shape.

The camera can be disposed in this center. The spatial field of view of at least approximately 360° can be divided into multiple segments. The center can lie on the common axis which can be formed as a substantially vertical axis or an oblique axis. This allows camera data of one segment to be evaluated independently of camera data of other segments.

Alternatively, the spatial field of view of at least approximately 360° can be reconstructed from partial fields of view of the two cameras of at least approximately 180°, if these are disposed on axes extending at a small distance from one another.

Camera data can be understood as cloud-related data which is caused by clouds. Additionally or alternatively, camera data can be understood in the following as cloud-related data which is caused by cloud shadows.

Additionally or alternatively, camera data can be understood in the following as data related to solar radiation, which is caused by intensities of at least one component of the global irradiance. The camera data can also be caused by intensities of multiple components of the global irradiance.

Here, camera data can be understood as images of the sky. Additionally or alternatively, camera data can be understood as images of areas of the sky. Additionally or alternatively, camera data can be understood as images of the earth surface. Additionally or alternatively, camera data can be understood as images of areas of the earth surface.

Additionally or alternatively, camera data can be the image features of one or more color channels of an image. Such image features can exist in the texture and/or structure and/or in the color or ratio of color channels and/or brightness. These image features can be caused by clouds or other elements in the sky. Additionally or alternatively, these image features can be caused by cloud shadows and/or other elements on the ground. Image features that are not caused by clouds and/or cloud shadows can be sorted out by appropriate methods and can therefore not be used for evaluation.

Additionally or alternatively, camera data can be the intensity values of one or more color channels and/or structural image features, particularly in the image area, of the sun. The intensity values and structural features can be created by the radiation impinging on the at least one lens of the respective camera and by the associated reflections and refractions and other optical and electronic effects.

The images and/or the image features and/or the intensity values can be evaluated. This can include capturing a current condition.

Additionally or alternatively, a change in the images and/or the image features and/or the intensity values can also be captured over time.

In the following, ascertaining a parameter is understood as the capture and/or calculation of a current value of the parameter. In addition, or alternatively, in the following, ascertaining the parameter is understood as the capture and/or calculation of a likely future value of the parameter. For example, the expected future value of the parameter can be ascertained based on the current and/or past camera data.

A parameter is understood in the following as a variable ascertained with or from the camera data. This variable can be a cloud shadow position and/or a cloud feature position and/or a cloud velocity and/or a cloud height. Additionally or alternatively, this variable can be a future cloud shadow position and/or a future cloud feature position and/or a future cloud velocity and/or cloud height.

In addition to or alternatively, this variable can also be a component of global irradiance and/or a combination of multiple components of the global irradiance or the global irradiance. The measured or ascertained values for the global irradiance component and/or for the combination of multiple components of global irradiance and/or the global irradiance can be further refined.

The determination of at least one component of the global irradiance can be understood in the following by capturing and/or calculating a current value of at least one component of the global irradiance. Additionally or alternatively, the determination of at least one component of the global irradiance can be understood as the calculation of a future value of at least one component of the global irradiance.

At least one component of the global irradiance can be understood as a variable determined with or from the camera data and/or a variable determined with or from the parameters.

A component of global irradiance can be understood as one of the following types of solar radiation or a combination of the following types of solar radiation: direct radiation, diffuse radiation, radiation reflected from the earth surface. All together correspond to the global irradiance.

An assembly is proposed for ascertaining at least one parameter for determining at least one component of a global irradiance, which assembly comprises an evaluation and control device as well as a camera assembly.

The at least one camera is fixed at a specified distance from an earth surface for ascertaining the at least one parameter. The camera assembly is designed to capture camera data in a spatial field of view of at least approximately 360° around the camera assembly.

Conveniently, a holding assembly can fix the at least one camera. In the case of two or more cameras, the cameras can be fixed by the same holding assembly. Optionally, cameras can also be fixed in different holding assemblies.

The spatial visual field of view of at least approximately 360° around the camera assembly is conveniently composed of a first partial spatial field of view and a second partial spatial field of view of at least approximately 180° each around the camera assembly, which is disposed along a common axis or, if two cameras are used, on two axes spaced at a small distance from one another, in particular wherein the common axis or the multiple axes are substantially oriented in a vertical direction, or wherein the common axis or the multiple axes are oriented at a tilt angle to the vertical direction.

The at least one camera of the camera assembly can be disposed on at least one axis forming the vertical axis or the oblique axis, wherein the spatial field of view extends up and down of at least approximately 360° along the vertical axis(s) or the oblique axis(s).

An upper partial spatial field of view of at least approximately 180° and a lower partial spatial field of view of at least approximately 180° can be formed, which have the common substantially vertical axis or oblique axis, in particular substantially vertical center axis or oblique center axis, or are accordingly spaced apart from one another on different axes. The upper partial spatial field of view and the lower partial spatial field of view can each form a top hemisphere and a bottom hemisphere.

The upper hemisphere and the lower hemisphere, with their straight rear surfaces, that is, their rear sides, can form a common horizontal surface perpendicular to the substantially vertical axis or oblique axis, in particular a circular area. The center of the camera assembly can be formed on the intersection of the common axis and the horizontal axis.

The at least one camera can be understood as an RGB camera or an infrared camera. For example, the at least one camera can capture 24 frames per second. These can be stamped with a corresponding time stamp. Other image generation rates can also be selected. In addition, extended setups with, for example, shading devices are conceivable to reduce an interference effect of direct sunlight.

In particular, the camera assembly can be designed to capture camera data in a field of view of at least approximately 360° around the camera assembly, wherein the camera data is suitable for deriving information concerning solar radiation and/or the position and/or properties of clouds.

The holding assembly can fix the camera for ascertaining at least one parameter at a specific distance above the ground. In this case, the holding assembly can be a local, fixed assembly, such as a suitable linkage or rig. Additionally or alternatively, the holding assembly can be a movable assembly, such as a drone which can be mobile-friendly and which fixes the at least one camera at a specified height in a specified location.

The holding assembly can be such that the camera assembly is disposed on the common axis and a spatial field of view of at least approximately 360° is formed.

The evaluation results of the camera data, for example of individual color channels, can be compared with the evaluation results of other color channels. Additionally or alternatively, evaluation results can be compared with different time stamps of a color channel. Another evaluation of the evaluation results with evaluation results having other time stamps or with evaluation results from another color channel is also possible.

In an example in which the field of view of at least approximately 360° is composed of two partial fields of view of at least approximately 180° in a specified location, the evaluation results of a first partial field of view of at least approximately 180° and the evaluation results of a second partial field of view of at least approximately 180° can be combined in an advantageous manner.

This will allow resorting to estimates or values from external data sources to be advantageously eliminated for ascertaining most parameters for determining at least one component of a global irradiance, thereby making ascertaining the parameters for a specified location more accurate and reliable than with usual assemblies which resort to estimates and values from external data sources. Furthermore, no further sensor units are required.

Usually, the irradiance of the at least one component of the global irradiance is indicated in relation to a surface which it impacts. This surface can be inclined to the earth surface and can also be facing the eart surface, for example.

This allows ascertaining the current direct radiation, the current diffuse radiation, the current radiation reflected from the earth surface, and the current global irradiance from the parameters and/or directly from the camera data. This advantageously allows estimating a current performance of a solar system.

In addition, a prediction for future diffuse radiation, future radiation reflected from the earth surface, and future global irradiance can be ascertained from the parameters by ascertaining a future value for solar radiation. This advantageously allows estimating a future performance of a solar system.

In addition to the parameters ascertained to predict the future solar radiation, current solar radiation values can also be used.

Advantageously, the field of view of at least approximately 360° around the camera assembly allows the advantages of an assembly having a sky camera oriented toward the sky, also known as a cloud camera, to be combined with the advantages of an assembly having a ground camera oriented toward the ground, also known as a shadow camera, and the disadvantages of the sky camera and the cloud camera to be compensated.

To achieve the advantages, the camera data which was captured in the field of view of at least approximately 360° can be evaluated. For example, camera data can advantageously be captured in a common location at the same time and evaluated for a common axis with cameras on a common axis or at axes spaced apart by a small distance.

By combining the advantages, a camera assembly having a field of view of at least approximately 360° can be sufficient to capture sufficient camera data to reliably capture and/or predict desired parameters. This means that additional cameras at other locations or other sensor units can be eliminated.

A large part of the sky can be captured and monitored, in particular clouds can be detected long before their shadows arrive in the monitored area, and corresponding predictions can be made.

A further advantage of the evaluation of the camera data, which are recorded in the field of view of at least approximately 360° around the camera assembly, is that some parameters, such as a cloud velocity above the ground, can be accurately and directly extracted from these camera data.

The monitorable and capturable portion of the ground floor depends, among other things, on a height at which the at least one camera which is oriented towards the ground is disposed.

To make a reliable prediction, ground cameras are usually disposed on high towers or mountain ridges to enlarge the portion of the ground they monitor. Due to the height, clouds hovering between the camera and the ground can prevent or complicate ground monitoring using these assemblies.

Advantageously, a prediction can be ascertained using camera data from at least one camera oriented toward the sky, which does not necessarily require a large portion of the ground to monitor the ground, such that the camera assembly can be disposed at a lower height above the ground, in contrast to known shadow camera assemblies.

For example, the holding assembly can fix the at least one camera at a distance of 1-100 m from the ground, which is common for albedo measurements. A minimum distance of the at least one camera from the ground can be dependent on the ground. For example, a height of 10 m should be chosen at locations with snow, uncut grass, or arable crops on the ground to avoid interference due to surface irregularities. Lower heights are also possible for surfaces with less vegetation and/or in areas with little snowfall.

Furthermore, the minimum height can be selected so that gradients of the intensities of the RGB channels of the at least one camera oriented towards the ground can be safely identified, so that the parameters which can be ascertained therefrom can be determined reliably and accurately.

A maximum distance of the at least one camera oriented towards the ground prevents low-lying clouds from making it difficult to capture camera data. This maximum distance is to be determined depending on the deployment purpose and location. For example, if clouds at heights of 500 m or more above are of interest to the camera, the at least one camera should be installed at a height of not more than 100 m to safely capture these clouds. If the assembly is also used to measure the radiation reflected from the ground, a lower distance is advantageous.

As the distance increases, so does the area that is included in measuring the radiation reflected from the ground. This area can potentially be impacted by undesirable influences such as trees, reflective objects, land use, etc.

Since the camera assembly is fixed at a maximum height of 100 m, the cost of the holding assembly can be reduced. In addition, such a stationary camera assembly can be installed easily and quickly at any location, such that the camera assembly is flexible.

Alternatively, a drone can simply fly at such a height and can also be used flexibly at multiple locations. This also makes it possible to change the location for the holding assembly after the desired parameters have been calculated.

This makes it easy and cost-effective to check a suitability of a location for a solar park, for example.

In addition, the camera assembly can be placed on a top edge of a building. The building can correspond to a monitoring building or distributor house of a solar system or to a residential building. No tower or other tall building is required. A field of view of the camera assembly restricted by the building can make it difficult to capture camera data and ascertain the at least one parameter.

The camera data can advantageously be ascertained by the inventive assembly at a common location. This can eliminate the need to transfer camera data between two locations and convert the data from one location to the other. This facilitates maintenance and operation of the inventive assembly.

In particular, a reduced number of cameras or a reduced number of camera assemblies can reduce an expense for a hardware item and thus the cost of the hardware.

According to a favorable embodiment of the assembly, the field of view of at least approximately 360° around the camera assembly in a specified location can be composed of a first partial field of view and a second field of view of at least approximately 180° each around the camera assembly. At least one first camera captures camera data in the first partial field of view and at least one second camera captures camera data in the second partial field of view, wherein the two fields of view of the cameras complement one another to form a field of view of at least approximately 360°. In particular, the cameras are each designed as a fish-eye camera.

The orientation of the fields of view can be selected at will. It is possible, for example, that the fields of view are oriented laterally, such that one camera captures a section of the ground and a section of the sky on one side, and the other camera captures a section of the ground and a section of the sky on an opposite side. The position and orientation of the cameras can be freely chosen as long as a total field of view of at least approximately 360° is recorded around the camera assembly. The camera assembly can be oriented along one common axis or along axes spaced apart at a small distance, wherein the one or multiple axes are substantially vertically oriented and capable of forming a substantially vertical axis, or they are tilted towards the vertical axis at a tilt angle, forming an oblique axis.

Advantageously, the monitoring of a specified partial field of view by a separate camera can facilitate the assignment of the camera data to the partial field of view and thereby facilitate interpretation and evaluation of the camera data.

For example, camera data can more easily be assigned to the at least one component of the global irradiance, if it is clear in which field of view it was captured. In an alternative exemplary embodiment, the field of view of at least approximately 360° can be divided into more than two partial fields of view. In addition, further cameras are conceivable which capture camera data in the additional partial fields of view.

According to a favorable embodiment of the assembly, at least one first camera can capture camera data as a sky camera in the first partial field of view, which is oriented towards the sky and forms an upper partial field of view.

At least one second camera can capture camera data as a ground camera in the second field of view, which is oriented towards the earth surface and forms a lower field of view. In particular, the cameras are designed as fish-eye cameras. The upper partial field of view and the lower partial field of view can have the common substantially vertical axis or oblique axis or be disposed on spaced-apart axes.

The use of multiple cameras can be advantageous in eliminating the use of an omnidirectional camera.

In addition, the camera data of the respective cameras can be easily assigned to the top or bottom panel. The cameras can be specially designed to monitor the sky and the ground.

Alternatively, a 360° camera with a field of view of at least approximately 360° around the camera assembly can capture camera data in the first partial field of view and capture camera data in the second partial field of view. In particular, the first partial field of view can form an upper partial field of view oriented toward the sky, and the second partial field of view can form a lower partial field of view oriented toward the earth surface.

The use of one camera can be advantageous in eliminating the use of multiple cameras. This makes installation easier. In addition, a single camera and a reduced number of cameras can minimize potential sources of error, for example when data is transmitted, or by inaccurately orienting the cameras and/or by calibrating the corresponding cameras. Associating the camera data with the upper or lower partial field of view can take place during the evaluation of the camera data.

The cameras used can produce high-resolution and high-quality images or camera data. Alternatively, surveillance cameras can be used. These are cheaper and can provide images with stronger artefacts. In an alternative embodiment, an assembly of cameras and parabolic mirrors is conceivable.

In contrast to known assemblies with sky cameras that can ascertain cloud heights and thus cloud velocities above the ground, the inventive assembly only monitors a single upper partial field of view, while standard sky camera assemblies with this power range monitor at least two upper partial fields of view and comprise at least two sky cameras.

In contrast to known ground camera assemblies, the inventive assembly only monitors a small portion of the ground, such that the ground camera can be disposed at a smaller distance from the ground than in the case of standard ground camera assemblies.

If the camera assembly is designed with a sky camera and a ground camera, the two cameras can be installed in the same location with an opposite orientation.

If the camera assembly is designed with a single camera, it is automatically located in one location.

Advantageously, the invention can reduce an expense of purchasing and operating a hardware item, since the advantages of a cloud camera assembly and a shadow camera assembly can be combined.

According to a favorable embodiment of the assembly, at least one evaluation and control device can extract camera data associated with the sky from the captured camera data and ascertain from these camera data associated with the sky at least one of the following parameters: a direct radiation and/or a diffuse radiation and/or a global irradiance GI and/or at least a position of cloud features and/or cloud-covered areas of the sky and/or an angular velocity of at least one cloud in the camera image from cloud positions and/or from the position of cloud features in the camera image between at least two time stamps.

Cloud features are understood in the following as image features indicating a cloud. A cloud position is an estimation of the position of a cloud or a cloud accumulation, since clouds are not fixed objects, and individual clouds are difficult to distinguish in a cloud formation.

In the case of a camera that only monitors the upper field of view, the camera data associated with the sky can be easily extracted, since almost all camera data of this camera can be associated with the sky. In the case of a camera that monitors both portions of the sky and portions of the ground, a prior evaluation of the camera data can allow association with the sky or the ground.

At least one evaluation and control device can use a corresponding programming method to ascertain the angular velocity of a cloud or of multiple clouds or a cloud formation from the camera images.

In a possible evaluation method to determine the position of cloud features and/or to calculate the angular velocity of a cloud or of multiple clouds or a cloud formation, image features corresponding to the position of the cloud or the positions of the clouds or cloud formation can be identified. To calculate the angular velocity of a cloud or of multiple clouds or of a cloud formation, a shift of Δm, Δn of image features in the camera image towards an x-axis and a y-axis between the times t₁=t₀ and t₂=t₀+Δt can be determined.

The shift can be represented by creating differential images d₁ of one color channel of the color channels. In this case, a first differential image d₁ can be created from a camera image at a first time t₁=t₀ and a camera image at a second time t₂=t₀+Δt. In addition, a second differential image d₂ can be created from the camera image at the second time t₂=t₀+Δt and a camera image at a third time t₃=t₀+2Δt.

The differential images d₁ and d₂ can be deskewed. Deskewing is understood to mean that the ascertained values are projected into a horizontal plane with an unknown height above the camera. The result of this projection are ortho images o₁ and o₂. Image features and their positions are identified from the ortho images o₁ and o₂.

In another step, the ortho images o₁ and o₂ can be converted into binary images b₁, b₂, wherein 2% of the pixels each get the value 1 and the other 98% of the pixels get the value 0, for example. These 2% of pixels have the largest difference in absolute value. This allows to ascertain sharp increases or drops from this color channel between the times t₀, t₀+Δt, t₀+2Δt.

In another step, these binary images can be compared in total by means of cross-correlation, or, in a refined method, the images can be compared section by section, for example. The shift Δm, Δn is equal to the shift for which the cross-correlation between the binary ortho images o₁ and o₂ reaches a maximum. This method can be performed for at least one color channel. Multiple color channels can also be evaluated in this way. Furthermore, further refinements and appropriate adjustments can be made in the procedure to determine the shift Δm, Δn of the cloud or clouds.

In an alternative method, image features and their shift Δm, Δn can also be determined by other means, for example using SIFT (scale invariant feature transform) or other machine learning methods.

With the help of the known time offset t₂−t₁ and Δm, Δn, the angular velocity in both directions x and y can then be calculated as:

$${v}_{x pix / s} = Δ m / ( {t}_{2} - {t}_{1} ) \\ {v}_{y pix / s} = Δ n / ( {t}_{2} - {t}_{1} )$$

Direct radiation and/or diffuse radiation can be determined by at least one evaluation and control device. This can be the same evaluation and control device that already ascertains the angular velocity of the cloud, or it can be another evaluation and control device.

As a basis, the intensity values of the RGB channels of at least one camera in the upper partial field of view or from 6the camera data associated with the sky are evaluated by the evaluation and control device.

These intensity values can be read directly from the corresponding camera. In a possible evaluation procedure, a physical camera model from the intensity values of the RGB channels of the camera image is used to calculate the radiation (radiance) received from a specific sky area. In addition, physically motivated corrections can be applied to improve the calculation. In an alternative exemplary embodiment, the physical camera model can be replaced by a purely statistical machine-based learning model (machine learning model).

In particular, an architecture using a Convolutional Neural Network followed by the Fully Connected Neural Network can replace or mimic or supplement the camera model or adapt it on its own, with appropriate training.

In one step of the evaluation method with basic assumptions of the physical camera model, a gamma correction common to cameras can be reversed to obtain a linearized RGB image from the RGB image of the respective camera.

This step can be eliminated if the corresponding camera does not perform a gamma correction, so that the gamma correction does not have to be reversed afterwards. This can be the case, for example, if the gamma correction of the corresponding camera is disabled or if the camera does not perform gamma correction for other reasons.

In another step of the evaluation method, for example, a pixel-by-pixel association of image areas with sky areas can take place via azimuth and zenith angles/vertical angles. Instead of a pixel-by-pixel association, other associations are also conceivable. An angular degree of the azimuth angle can be indicated from the south, west, north, and east.

Geometric calibrations of the corresponding camera and transformations based thereon can be applied when associating the image areas with sky areas. Alternatively, associating image areas with sky areas can roughly take place using azimuth and zenith angles/vertical angles. For example, an association without using calibrations is conceivable. The calibrations and transformations based thereon can be implemented as a machine-based learning model (machine learning model) and can be continuously improved.

In another step of the evaluation method, intensities of the color channels of the linearized RGB image can be weighted and summed. The weighting can achieve a sensitivity of the corresponding camera as uniformly as possible in the visible wavelength range.

In another step of the evaluation method, a multiplication with a broadband correction can take place, which takes into account the proportion of broadband solar radiation that originates from the non-visible wavelength range. In addition, a multiplication with a calibration factor which takes into account the sensitivity of the camera is conceivable.

In addition, it is possible to apply at least one correction to take into account interferences with the measurement, such as a lens refraction, image saturation, influence of the exposure control of the corresponding camera. Additionally or alternatively, applied correction factors, such as broadband correction, the calibration factor, the correction of interferences, can be partially summarized or rewritten. In addition, these corrections can be replaced or supplemented by statistically determined corrections, for example via machine learning, in particular based on image features.

In another step of the evaluation method, the radiation (radiance) received from different sky areas can be determined, for example by a projection of diffuse and/or direct radiation in any horizontal plane or plane inclined towards the ground, including a plane facing the ground. The association of the image areas with sky areas and an integration across image areas/sky areas can be used. If necessary, global radiation can also be determined in inclined planes and also in planes facing the ground.

In an alternative embodiment of the method, the partial steps, such as the application of a physical camera model and/or the assignment of image areas to sky areas and/or the application of physically motivated corrections and/or the projection to any plane, can be partially or as a whole imitated by a so-called machine-learning model for the determination of direct and diffuse radiation in any plane.

In a simplest embodiment of the assembly, values corresponding to the sum of diffuse radiation and direct radiation can be determined by evaluating the intensities of the RGB channels, from camera data associated with the upper partial field of view or from camera data associated with the sky. Extensions would be possible, so that ascertainment of separate values for diffuse radiation and direct radiation can be made possible.

Advantageously, ascertainment of the direct radiation and/or diffuse radiation can be used to ascertain the performance of a solar plant at the location of the inventive assembly and to evaluate a solar resource at the location. No additional sensors or sensor units, such as pyranometers, are required. Radiation can be ascertained just by the at least one camera and its camera data.

Advantageously, knowledge of the areas covered by clouds in the upper partial field of view can be used for further assessment of the ascertained radiation. For example, the diffuse radiation can increase due to clouds and a direct radiation can decrease due to clouds. Different radiation conditions can exist at the location in the case of a different weather. Current and future radiation conditions can be ascertained at least partially by ascertaining cloud positions and the velocity of clouds.

According to a favorable embodiment of the assembly, the evaluation and control device can extract camera data associated with the earth surface from the captured camera data and ascertain from these camera data associated with the earth surface at least one of the following parameters: a radiation reflected at the earth surface and/or an albedo of the earth surface and/or at least one cloud shadow position and/or a velocity of at least one cloud above the earth surface from the cloud shadow positions between at least two time stamps.

In the case of a camera that only monitors the lower field of view, the camera data associated with the earth surface can be easily extracted, since almost all camera data of this camera can be associated with the ground. In the case of a camera that monitors both portions of the sky and portions of the ground, a prior evaluation of the camera data can allow association with the sky or the ground.

The velocity of a cloud or of multiple clouds above the ground can be ascertained by at least one evaluation and control device, from the camera images of the lower partial field of view or from the camera data associated with the earth surface. This can be one of the evaluation and control devices which evaluates the camera data of the upper partial field of view or the camera data associated with the sky, or can be another evaluation and control device.

The corresponding evaluation method is similar to the one used to determine the angular velocity of the clouds from images of the upper partial field of view or from the camera data associated with the sky, respectively.

In an alternative method, image features that correspond to the position of a cloud shadow or to positions of multiple cloud shadows and their shift Δm, Δn can also be ascertained by other means, for example using SIFT (scale invariant feature transform) or other machine learning methods.

In a possible evaluation method, image features that correspond to the position of a cloud shadow or the positions of multiple cloud shadows can be detected and a shift of Δm, Δn of image features in the camera image towards an x-axis and a y-axis between the times t₁=t₀, t₂=t₀+Δt, t₃=t₀+2Δ can be ascertained.

These images can be converted into ortho images using the known height profile of the earth surface of the monitored area and geometric calibrations of the camera. The projection height is known in contrast to the evaluation of the upper partial field of view or the evaluation of the camera data associated with the sky. In the corresponding ortho images, each pixel thus corresponds to a square partial section of the monitored area. Differential images can be calculated from the ortho images converted to grayscale. Other outputs than grayscale are possible. As with the ascertainment of angular velocity, differential images can be converted into binary images. A cross-correlation can be used to determine the shift of image pixels Δm, Δn, which can be associated with a corresponding shift of Δx, Δy of cloud shadows in the monitored area. The amount of this “absolute” velocity of cloud shadows above the ground is then calculated as

$${v}_{m / s} = \frac{\sqrt{Δ {m}^{2} + Δ {n}^{2}}}{Δ t} \cdot {k}_{SC} ,$$

wherein the scaling factor k_{sc} (unit m/pixel) indicates the known page length of an image pixel in meters.

Since the velocity of cloud shadows above the ground also corresponds to the velocity of the corresponding cloud above the ground, no two sky cameras which monitor different upper partial fields of view are advantageously required to ascertain the cloud velocity above the ground, since the cloud velocity can be easily determined from the one lower partial field of view or from the camera data associated with the earth surface. In addition, the use of estimates in the calculation of cloud velocity can be eliminated, which allows a reliable and accurate value to be calculated for cloud velocity above the ground.

The cloud velocity above the ground is understood in the following as a velocity of the clouds compared to imaginary fixed points on the ground. From the determined cloud velocity and the current cloud position, a future cloud position and a corresponding change in global irradiance can advantageously be determined or predicted in a specified area.

The radiation reflected from the earth surface and/or the albedo of the ground can be ascertained by at least one evaluation and control device. This can be the same evaluation and control device that already ascertains another parameter, or this can be another evaluation and control device.

Ascertaining the radiation reflected from the ground is similar to ascertaining direct radiation and/or diffuse radiation. As a basis, the intensity values of the RGB channels of at least one camera, which ascertains camera data from the lower partial field of view, are evaluated by the corresponding evaluation and control device.

These intensity values can be read directly from the corresponding camera, if it exclusively monitors the ground. Otherwise, the relevant camera data can be separated from the camera data which is not relevant. In a possible evaluation method, a physical camera model from the intensity values of the RGB channels of the camera image is used to calculate the radiation received from a specific ground area. In addition, physically motivated corrections can be applied to improve the calculation. In an alternative exemplary embodiment, the physical camera model can be replaced by a purely statistical machine-based learning model (machine learning model). In particular, an architecture using a Convolutional Neural Network followed by the Fully Connected Neural Network can replace or mimic or supplement the camera model or adapt it on its own, with appropriate training.

In one step of the evaluation method with basic assumptions of the physical camera model, a gamma correction common to cameras can be reversed to obtain a linearized RGB image from the RGB image of the respective camera. This step can be eliminated if the corresponding camera does not perform a gamma correction, so that the gamma correction does not have to be reversed afterwards. This can be the case, for example, if the gamma correction of the corresponding camera is disabled or if the camera does not perform gamma correction for other reasons.

In another step of the evaluation method, a pixel-by-pixel association of image areas with ground areas can be performed using the known height profile of the earth surface of the monitored area, for example. Each pixel can correspond to a square partial section of the monitored area.

Alternatively, the pixel-by-pixel association of image areas with ground areas can be taken over from cloud velocity ascertainment. Instead of a pixel-by-pixel association, other associations are also conceivable.

Geometric calibrations of the corresponding camera and transformations based thereon can be applied when associating the image areas with ground areas. Furthermore, an association without using calibrations is conceivable. The calibrations and transformations based thereon can be implemented as a machine-based learning model (machine learning model) and can be continuously improved.

In another step of the evaluation method, intensities of the color channels of the linearized RGB image can be weighted and summed. The weighting can achieve a sensitivity of the corresponding camera as uniformly as possible in the visible wavelength range.

In another step of the evaluation method, a multiplication with a broadband correction can take place, which takes into account the proportion of broadband solar radiation that originates from the non-visible wavelength range. In addition, a multiplication with a calibration factor which takes into account the sensitivity of the camera is conceivable.

In addition, it is possible to apply at least one correction to take into account interferences with the measurement, such as a lens refraction, image saturation, influence of the exposure control of the corresponding camera. Additionally or alternatively, applied correction factors, such as broadband correction, the calibration factor, the correction of interferences, can be partially summarized or rewritten.

In addition, these corrections can be replaced or supplemented by statistically determined corrections, for example via machine learning, in particular based on image features.

In another step of the evaluation method, the radiation impinging on one plane and being reflected from the ground can also be ascertained for inclined planes and also for planes oriented towards the ground.

In an alternative embodiment of the evaluation method, the partial steps, such as the application of a physical camera model and/or the assignment of image areas to sky areas and/or the application of physically motivated corrections and/or a projection to any plane for determining the radiation reflected from the ground can be partially or as a whole imitated by a machine-learning model.

In addition, in another step, the current albedo of the ground or a more detailed reflectance of the ground can be derived from the ascertained reflected radiation and the ascertained direct radiation and the ascertained diffuse radiation. Advantageously, the evaluation of the camera data of the lower field of view or of the camera data associated with the earth surface and the upper field of view or camera data associated with the sky makes it possible to ascertain the current albedo or reflectance of the ground in the monitored area, for example due to weather, seasonal, or vegetation-related conditions. Therefore, resorting to a less accurate estimate of the albedo or reflectance of the ground, respectively, can be eliminated. This will allow a better assessment of solar radiation in this area.

Advantageously, the reflectance or albedo of the ground and/or the reflected radiation and/or direct radiation and/or the diffuse radiation can be indicated in an angularly resolved and spectrally resolved manner.

In addition, the global and diffuse irradiance in any inclined plane can be calculated from the radiation from the different areas of the ground and from the angularly and spectrally resolved reflectance of the ground or albedo, respectively, including those planes that point to the ground. In this way, the radiation on the rear of the module can be calculated individually for each module for bifacial photovoltaic modules, taking into account the typically complex geometry of the power plants. This setup can also be supported by combination with a pyranometer.

The reflectance corresponds to the reflection factor of the surface. The reflection factor indicates the ratio of a radiant power reflected from a surface to a radiant power impinging on the surface.

An angularly resolved reflectance is understood to mean information in the sense of a bidirectional reflectance distribution function or derived quantities such as a detailed composition of the albedo, in particular a black-sky albedo and white-sky albedo.

A spectrally resolved reflectance is the ratio of the radiant power reflected by a surface at a specific wavelength or wavelength range and the radiant power impinging on the surface at that particular wavelength or in that particular wavelength range.

In addition, camera data associated with the camera data of the lower field of view or the earth surface, respectively, can be used to monitor pollution or damage to a solar system and other solar collectors to be able to arrange cleaning or repair, if necessary.

According to a favorable embodiment of the assembly, at least one evaluation and control device can ascertain a height of the clouds from the velocity of at least one cloud above the earth surface and the angular velocity of at least one cloud in the camera image.

The cloud velocity above the ground can be calculated in the upper partial field of view or from the camera data associated with the sky, respectively, based on the angular velocity v_{pix/s}:

$${v}_{m / s} = {v}_{pix / s} 2 tan θ {H}_{2} / N$$

The height H₂ of the cloud therefore is:

$${H}_{2} = \frac{{v}_{m / s} N}{{v}_{pix / s} 2 tan θ}$$

The angle θ corresponds to the maximum zenith angle up to which the upper field of view of 180° or at least approximately 180° around the camera assembly is evaluated. N corresponds to the diameter in pixels of the circular image area, which represents the sky area having a zenith angle less than or equal to θ. The angle θ and the parameter N can be determined from the camera image of the upper field of view of at least approximately 180° around the camera assembly, v_{m/s} corresponds to the ascertained velocity of the cloud above the ground, and v_{pix/s} corresponds to the ascertained angular velocity of the cloud. H₂ corresponds to the height of the cloud projected over the camera assembly or above the at least one camera of the camera assembly oriented towards the sky.

Since the distance of at least one camera to the ground is known, the known height profile of the monitored area, the current cloud position and the height of the cloud projected over the camera can be used to calculate the actual height of the cloud above the ground at its current position. Refinement of the calculations is possible.

In particular, the evaluation and control device can ascertain a future cloud position using the height of the clouds, the current position of the clouds and the cloud velocity above the earth surface. From this, a future shading or a future global irradiance can be estimated or calculated in a specified area. This allows more accurate short-term forecasts of solar radiation with only one camera assembly at the same location, wherein the cameras used are installed just a few meters above the ground. Advantageously, this allows an early reaction to shadings or a fluctuation in the performance of the solar system to be expected. The camera data can advantageously be ascertained at a common location, which makes it easier to maintain and operate the inventive assembly and makes it more cost-effective.

According to a favorable embodiment of the assembly, at least one evaluation and control device can extrapolate the velocity of clouds above the earth surface and/or the angular velocity of clouds in the camera image in time and space.

This allows both the angular velocity of clouds in the camera image and the velocity of clouds above the earth surface to be averaged/extrapolated in time and space to obtain greater temporal and spatial coverage.

This also makes it possible to determine the cloud height and the cloud velocity of clouds whose shadows are not (yet) captured in the lower field of view or by camera data associated with the earth surface, respectively. The temporal and spatial extrapolation can compensate that the lower field of view covers a small portion and thus less cloud shadows than clouds or cloud features in the upper partial field of view. Due to the temporal and spatial extrapolation, it is not necessary to use the data of a cloud and its shadow for evaluation. The shadows of other clouds can also be used to ascertain the cloud height of a cloud or cloud feature captured in the upper partial field of view or captured from camera data associated with the sky. This evaluation is less accurate than if the camera data of a cloud or cloud feature and its shadow are used for evaluation. However, it is possible to ascertain the cloud height continuously. For known systems, such as lidar systems or ceilometer systems, cloud heights are only ascertained selectively.

According to a favorable embodiment of the assembly, the at least one evalaution and control device can determine at least one current and/or future value of at least one component of the global irradiance in a spectrally and/or angularly resolved manner from the camera data and/or the ascertained parameters. Angularly resolved radiation information, in particular the radiance, can be weighted and integrated into the plane of interest corresponding to a projection. The angularly resolved information itself can be of interest to a user, so in that case the weighting and integration can be eliminated. Angularly resolved capturing of at least one component of global radiation can determine the current and/or future albedo of the ground.

Furthermore, a current and/or future irradiance of a radiation impinging on a plane with a known inclination to the ground, such as a rear of a bifacial photovoltaic module, can be determined in an advantageous manner. Additional support by a pyranometer or other suitable sensor is possible. Advantageously, no additional sensors such as pyranometers are required to resolve the irradiances of the components of global radiation in a spectrally and/or angularly resolved manner, or to ascertain irradiances on planes inclined to the earth surface. This can reduce costs of the assembly.

According to a favorable embodiment of the assembly, at least one evaluation and control device can ascertain at least one component of global radiation on an inclined surface, in particular an arbitrarily oriented surface. This advantageously allows ascertaining an optimal angle of inclination of solar modules, including bifacial photovoltaic modules. Alternatively or additionally, if angles of inclination are known, a current and/or an expected performance can be ascertained of solar modules, including bifacial photovoltaic modules.

Advantageously, the inventive assembly allows calculation of almost any parameter required for ascertaining and predicting at least one component of the global irradiance by means of the camera assembly at one location. No additional sensors or other camera assemblies are required. In addition, shortest-term forecasts of solar radiation can be created with the inventive assembly. At the same time, this setup also allows improved monitoring of solar power plants or monitoring in other areas, such as airports.

It is proposed to use an assembly for ascertaining at least one parameter to determine at least one component of a global irradiance, wherein camera data is captured in a field of view of at least approximately 360° around the camera assembly, wherein information concerning solar radiation and/or the position and/or properties of clouds is derived from the camera data.

The definitions for the use of the assembly are substantially the same as for the assembly for ascertaining at least one parameter to determine at least one component of a global irradiance, and therefore repeating these definitions, such as of cloud features, angularly resolved reflectance and/or spectrally resolved reflectance, is not required.

Advantageously, when using the assembly, the advantages of an assembly having a sky camera oriented towards the sky, also known as a cloud camera, can be combined with the advantages of an assembly having a ground camera oriented towards the ground, also known as a shadow camera, and thus compensating the disadvantages of the sky camera and the ground camera, due to the spatial field of view of at least approximately 360° around the camera assembly.

To achieve the advantages, the camera data which are associated with the spatial field of view of at least approximately 360° around the camera assembly, are evaluated. In addition, the camera data of the field of view of at least approximately 360° around the camera assembly, are advantageously captured simultaneously at a common location and evaluated for this location.

By combining the advantages, a camera assembly having a field of view of at least approximately 360° can be sufficient to capture sufficient camera data to reliably capture and/or predict desired parameters. This means that additional cameras at other locations or other sensor units can be eliminated, thereby reducing costs and reducing a required evaluation effort.

An advantage of the evaluation of the camera data of an upper partial field of view of at least approximately 180° around the camera assembly or from the evaluation of camera data associated with the sky is that a large portion of the sky can be captured and monitored, in particuar, clouds can be detected long before their shadows arrive in the monitored area, and corresponding predictions can be made.

An advantage of the evaluation of the camera data of the lower partial field of view of at least approximately 180° around the camera assembly is that some parameters, such as a cloud velocity above the ground, can be extracted precisely and directly from this camera data. The monitorable and capturable portion of the ground depends, among other things, on a height at which the at least one camera which captures the lower partial field of view of at least approximately 180° around the camera assembly is disposed.

To make a reliable prediction, ground cameras are usually disposed on high towers or mountain ridges to enlarge the portion of the ground they monitor. Due to the height, clouds hovering between the camera and the ground can prevent or complicate ground monitoring using these assemblies.

Advantageously, a prediction can be ascertained using camera data from at least one camera oriented towards the sky or from camera data associated with the sky, which does not necessarily require a large portion of the ground to monitor the ground, such that the camera assembly can be disposed at a lower height above the ground, in contrast to known shadow camera assemblies. For example, the holding assembly can fix the at least one camera at a distance of 1-100 m from the ground, which is common for albedo measurements. Selecting the minimum distance of the at least one camera from the ground can be dependent on the ground. For example, a height of 10 m should be chosen at locations with snow, uncut grass, or arable crops on the ground to avoid interference due to surface irregularities. Lower heights are also possible for surfaces with less vegetation and/or in areas with little snowfall.

Furthermore, the minimum height can be selected so that gradients of the intensities of the RGB channels of the at least one camera oriented towards the ground can be safely identified, so that the parameters which can be ascertained therefrom can be determined reliably and accurately.

A maximum distance of the at least one camera oriented towards the ground prevents low-lying clouds from making it difficult to capture camera data. This maximum distance is determined depending on the deployment purpose and location. For example, if clouds at heights of 500 m or more above are of interest to the camera, the at least one camera should be installed at a height of not more than 100 m. If the assembly is also used to measure the radiation reflected from the ground, a lower distance is advantageous.

As the distance increases, so does the area that is included in measuring the radiation reflected from the ground. This area can potentially be impacted by undesirable influences such as trees, reflective objects, land use, etc.

Since the camera assembly is fixed at most at a height of 100 m, the cost of the holding assembly can be reduced. In addition, such a stationary camera assembly can be installed easily and quickly at any location, such that the camera assembly is flexible.

Alternatively, a drone can simply fly at such a height and can also be used flexibly at multiple locations. This also makes it possible to change the location after the desired parameters have been calculated.

The low height of the camera assembly or the use of a drone makes it easy and cost-effective to check a suitability of a location for a solar park, for example. No tower or other tall building is required.

Advantageously, the camera data can be ascertained by the inventive assembly at a common location, which eliminates the need to transfer camera data between two locations and to convert the data from one location to another. In particular, a reduced number of cameras or a reduced number of camera assemblies can reduce an expense for a hardware item and thus the cost of the hardware.

According to a favorable embodiment of the use of the assembly, the field of view of the camera assembly at a predetermined location can be composed of a first partial field of view and a second partial field of view, each of at least approximately 180° around the camera assembly, and camera data in the first partial field of view can be captured with at least one first camera and camera data in the second partial field of view can be captured with at least one second camera, wherein the two partial fields of view of the cameras complement each other to form a spatial field of view of at least approximately 360°. Advantageously, associating camera data with the partial fields of view can be facilitated in this way.

In particular, camera data can be captured in the first partial field of view, which is orientated towards the sky and forms an upper partial field of view, using at least one first camera as a sky camera. Camera data can be captured in the second partial field of view, which is oriented towards the earth surface and forms a lower partial field of view, using at least one second camera as a ground camera.

Alternatively, a 360° camera with a field of view of at least approximately 360° around the camera assembly can capture camera data in the first partial field of view and camera data in the second partial field of view. In particular, the first partial field of view can form an upper partial field of view oriented towards the sky, and the second partial field of view can form a lower partial field of view oriented towards the earth surface. In particular, the first partial field of view can form an upper partial field of view oriented toward the sky, and the second partial field of view can form a lower partial field of view oriented toward the earth surface in this case.

The use of one camera can be advantageous in eliminating the use of multiple cameras. This makes installation easier. In addition, a reduced number of cameras due to a single camera can minimize potential sources of error, for example when data is transmitted, or due to inaccurately orienting the cameras and/or due to calibrating the corresponding cameras. Associating the camera data with the upper or lower partial field of view can take place during the evaluation of the camera data.

Advantageously, the camera data of the respective cameras can be easily associated with the upper partial field of view or the lower partial field of view. In contrast to known ground camera assemblies, the inventive assembly only monitors a small portion of the ground, such that the ground camera or the camera which captures camera data associated with the ground can be disposed at a smaller distance from the ground than in the case of usual ground camera assemblies.

If the camera assembly is designed with a sky camera and a ground camera, the two cameras can be installed at the same location with an opposite orientation.

Advantageously, the inventive use of the assembly can reduce an expense of purchasing and operating a hardware item, since the advantages of a cloud camera assembly and a shadow camera assembly can be combined.

According to a favorable embodiment of the use of the assembly, camera data associated with the sky from the can be extracted from the captured camera data and at least one of the following parameters can be ascertained from these camera data associated with the sky: a direct radiation and/or a diffuse radiation and/or a global irradiance and/or at least a position of cloud features and/or cloud-covered areas of the sky and/or an angular velocity of at least one cloud in the camera image from cloud positions WP and/or from the position of cloud features in the camera image between at least two time stamps.

Here, from the captured camera data of the upper partial field of view, image features or camera data associated with the sky, which correspond to the position of the cloud or the positions of the clouds, can be detected and a shift Δm, Δn of image features in the camera image towards an x-axis and a y-axis between the times t₁=t₀ and t₂=t₀+Δt can be ascertained.

The shift can be represented by creating differential images d₁ of one color channel of the existing color channels. In this case, a first differential image d₁ can be created from a camera image at a first time t₁=t₀ and a camera image at a second time t₂=t₀+Δt. In addition, a second differential image d₂ can be created from the camera image at the second time t₂=t₀+2Δt and a camera image at a third time t₃=t₀+2Δt. The differential images d₁ and d₂ can be deskewed. Deskewing is understood to mean that the ascertained values are projected into a horizontal plane with an unknown height above the camera. The result of this projection are ortho images o₁ and o₂. Image features and their positions are identified from the ortho images o₁ and o₂.

In another step, the ortho images o₁ and o₂ can be converted into binary images b₁, b₂, wherein 2% of the pixels each get the value 1 and the other 98% of the pixels get the value 0, for example. These 2% of pixels have the largest difference in absolute value. This allows to ascertain sharp increases or drops from this color channel between the times t₀, t₀+Δt, t₀+2Δt. In another step, these binary images can be compared in total by means of cross-correlation, or, in a refined method, the images can be compared section by section, for example.

The shift Δm, Δn is equal to the shift for which the cross-correlation between the binary ortho images o₁ and o₂ reaches a maximum. This method can be performed for at least one color channel. Multiple color channels can also be evaluated in this way. Furthermore, further refinements and appropriate adjustments can be made in the procedure to determine the shift Δm, Δn of the cloud or clouds.

In an alternative method, image features and their shift Δm, Δn can also be determined by other means, for example using SIFT (scale invariant feature transform) or other machine learning methods.

With the help of the known time offset t₂−t₁ and Δm, Δn, the angular velocity in both directions x and y can then be calculated as:

$${v}_{x pix / s} = Δ m / ( {t}_{2} - {t}_{1} ) \\ {v}_{y pix / s} = Δ n / ( {t}_{2} - {t}_{1} )$$

The velocity of the cloud above the ground can be ascertained from the angular velocity

$${v}_{m / s} = {v}_{pix / s} 2 tan θ {H}_{2} / N$$

The angle θ corresponds to the maximum zenith angle up to which the upper partial spatial field of view of at least approximately 180° around the camera assembly is evaluated. N corresponds to the diameter in pixels of the circular image area, which represents the sky area having a zenith angle less than or equal to θ. The angle θ and the parameter N can be determined from the camera image of the upper partial field of view of at least approximately 180° around the camera assembly or from the camera data associated with the sky. v_{pix/s} corresponds to the ascertained angular velocity of the cloud. H₂ corresponds to the height of the cloud projected over the camera assembly or above the at least one camera of the camera assembly oriented towards the sky. This is not known in known cloud camera assemblies and is determined by measurement data of other measuring assemblies, in part in other locations.

The basis for the determination of direct radiation and/or diffuse radiation are the intensity values of the RGB channels of at least one camera, which monitors the upper partial field of view or areas of the upper partial field of view. These intensity values can be read directly from the corresponding camera.

In a possible evaluation method, a physical camera model from the intensity values of the RGB channels of the camera image is used to calculate the radiation (radiance) received from a specific sky area. In addition, physically motivated corrections can be applied to improve the calculation. In an alternative exemplary embodiment, the physical camera model can be replaced by a purely statistical machine-based learning model (machine learning model).

In particular, an architecture using a Convolutional Neural Network followed by the Fully Connected Neural Network can replace or supplement or mimic the camera model or adapt it on its own, with appropriate training.

In one step of the evaluation method with basic assumptions of the physical camera model, a gamma correction common to cameras can be reversed to obtain a linearized RGB image from the RGB image of the respective camera. This step can be eliminated if the corresponding camera does not perform a gamma correction, so that the gamma correction does not have to be reversed afterwards. This can be the case, for example, if the gamma correction of the corresponding camera is disabled or if the camera does not perform gamma correction for other reasons.

In another step of the evaluation method, for example, a pixel-by-pixel association of image areas with sky areas can take place via azimuth and zenith angles/vertical angles. Instead of a pixel-by-pixel association, other associations are also conceivable. An angular degree of the azimuth angle can be indicated from the south, west, north, and east.

Geometric calibrations of the corresponding camera and transformations based thereon can be applied when associating the image areas with sky areas. Alternatively, associating image areas with sky areas can roughly take place using azimuth and zenith angles/vertical angles. For example, an association without using calibrations is conceivable. The calibrations and transformations based thereon can be implemented as a machine-based learning model (machine learning model) and can be continuously improved.

In another step of the evaluation method, intensities of the color channels of the linearized RGB image can be weighted and summed. The weighting can achieve a sensitivity of the corresponding camera as uniformly as possible in the visible wavelength range.

In another step of the evaluation method, a multiplication with a broadband correction can take place, which takes into account the proportion of broadband solar radiation that originates from the non-visible wavelength range. In addition, a multiplication with a calibration factor which takes into account the sensitivity of the camera is conceivable.

In addition, it is possible to apply at least one correction to take into account interferences with the measurement, such as a lens refraction, image saturation, influence of the exposure control, of the corresponding camera. Additionally or alternatively, applied correction factors, such as broadband correction, the calibration factor, the correction of interferences, can be partially summarized or rewritten. In addition, these corrections can be replaced or supplemented by statistically determined corrections, for example via machine learning, in particular based on image features.

In another step of the evaluation method, the radiation (radiance) received from different sky areas can be determined, for example by a projection of diffuse and/or direct radiation in any horizontal plane or plane inclined towards the ground, including a plane facing the ground.

The association of the image areas with sky areas and an integration across image areas/sky areas can be used. If necessary, global irradiance can also be determined in inclined planes and also in planes inclined towards the ground.

In an alternative embodiment of the method, the partial steps, (application of a physical camera model, assignment of image areas to sky areas, application of physically motivated corrections, projection to any plane) can be partially or as a whole imitated by a so-called machine-learning model for the determination of direct and diffuse radiation in any plane.

In a simplest embodiment of the assembly, values corresponding to the sum of diffuse radiation and direct radiation can be ascertained by evaluating the intensities of the RGB channels, from camera data associated with the upper partial field of view or from camera data associated with the ground. Extensions would be possible, so that ascertainment of separate values for diffuse radiation and direct radiation can be made possible.

Advantageously, ascertainment of the direct radiation and/or the diffuse radiation can be used to ascertain the performance of a solar plant at the location of the inventive assembly and to evaluate a solar resource at the location. The radiation can only be determined by at least one camera and its camera data, as well as by an evaluation and control device. No additional sensors or the like are required.

Advantageously, knowledge of the sky areas covered by clouds in the upper partial field of view can be used for further assessment of the ascertained radiation.

For example, the diffuse radiation can increase due to clouds and a direct radiation can decrease due to clouds. Different radiation conditions can exist at the location in the case of a different weather. Current and future radiation conditions can be ascertained at least partially by ascertaining cloud positions and the velocity of clouds.

According to a favorable embodiment of the use of the assembly, a velocity of at least one cloud above the earth surface can be determined from the captured camera data of the lower partial field of view or from the camera data associated with the earth surface, a radiation reflected from the earth surface and/or an albedo of the earth surface and or at least one cloud shadow position and or from the cloud shadow positions between at least two time stamps.

The velocity of a cloud or of multiple clouds above the ground can be ascertained from the camera images of the lower partial field of view or from the camera data associated with the earth surface.

The corresponding evaluation method is similar to the one used to determine the angular velocity of the clouds from images of the upper partial field of view or from the camera data associated with the sky, respectively.

In an alternative method, image features that correspond to the position of at least one cloud shadow and their shift Δm, Δn can also be ascertained by other means, for example using SIFT (scale invariant feature transform) or other machine learning methods.

In a possible method, image features that correspond to the position of a cloud shadow or the positions of multiple cloud shadows can be detected and a shift of Δm, Δn of image features in the camera image towards an x-axis and a y-axis between the times t₁=t₀, t₂=t₀+Δt, t₃=t₀+2Δ can be ascertained.

The shift can be represented by creating differential images d₁ of one color channel of the existing color channels. In this case, a first differential image d₁ can be created from a camera image at a first time t₁=t₀ and a camera image at a second time t₂=t₀+Δt. In addition, a second differential image d₂ can be created from the camera image at the second time t₂=t₀+Δt and a camera image at a third time t₃=t₀+2Δt. The differential images d₁ and d₂ can be deskewed. Deskewing is understood to mean that the images are projected below the camera using the known height profile of the earth surface of the monitored area, as well as geometric calibrations of the camera at ground level. The result of this projection are ortho images o₁ and o₂. Image features and their positions are identified from the ortho images o₁ and o₂. The projection height is known here, in contrast to the evaluation of the upper partial field of view of at least approximately 180° around the camera assembly. In the corresponding ortho images, each pixel thus corresponds to a square partial section of the monitored area. Differential images can be calculated from the ortho images converted to grayscale. Other outputs than grayscale are possible.

As with the ascertainment of angular velocity, differential images can be converted into binary images. For example, 2% of pixels can receive the value 1 and the other 98% of pixels can receive the value 0. These 2% of pixels have the largest difference in absolute value. This allows to ascertain sharp increases or drops from this color channel between the times t₀, t₀+Δt, t₀+2Δt.

In another step, these binary images can be compared in total by means of cross-correlation, or, in a refined method, the images can be compared section by section, for example.

The shift Δm, Δn of the image pixels is equal to the shift for which the cross-correlation between the binary ortho images o₁ and o₂ reaches a maximum. The displacement of the difference m, in the image pixels can be attributed to a corresponding shift of the difference x, difference y of the cloud shadows in the monitored area. This method can be performed for at least one color channel. Multiple color channels can also be evaluated in this way. Furthermore, further refinements and appropriate adjustments can be made in the method to ascertain the shift Δm, Δn of the image pixels of the cloud shadow or cloud shadows, respectively.

The amount of this “absolute” velocity of cloud shadows above the ground is then calculated as

$${v}_{m / s} = \frac{\sqrt{Δ {m}^{2} + Δ {n}^{2}}}{Δ t} \cdot {k}_{SC} ,$$

wherein the scaling factor k_{sc} (unit m/pixel) indicates the known page length of an image pixel in meters.

Since the velocity of the cloud shadows above the ground also corresponds to the velocity of the corresponding cloud above the ground, no two sky cameras which monitor different upper partial fields of view are advantageously required to ascertain the cloud velocity above the ground, since the cloud velocity can be easily ascertained from the one lower partial field of view or from the camera data associated with the earth surface, respectively.

In addition, the evaluation of the lower partial field of view provides more additional information than the evaluation of another upper partial field of view. In addition, the use of estimates in the calculation of cloud velocity can be eliminated, which allows a reliable and accurate value to be calculated for cloud velocity above the ground.

The cloud velocity above the ground is understood in the following as a velocity of the clouds compared to imaginary fixed points on the ground. Advantageously, a future cloud position and a corresponding change in global irradiance in a specified area can be ascertained or predicted from the ascertained cloud velocity and the current cloud position.

The radiation reflected from the earth surface and/or the albedo of the ground can also be ascertained. Ascertaining the radiation reflected from the ground is similar to ascertaining direct radiation and/or diffuse radiation.

As a basis, the intensity values of the RGB channels of at least one camera in the lower partial field of view or the camera data associated with the earth surface, respectively, are evaluated. These intensity values can be read directly from the corresponding camera or from the camera data associated with the earth surface.

In a possible evaluation method, a physical camera model from the intensity values of the RGB channels of the camera image is used to calculate the radiation received from a specific ground area. In addition, physically motivated corrections can be applied to improve the calculation.

In an alternative exemplary embodiment, the physical camera model can be replaced by a purely statistical machine-based learning model (machine learning model). In particular, an architecture using a Convolutional Neural Network followed by the Fully Connected Neural Network can replace or mimic or supplement the camera model or adapt it on its own, with appropriate training.

In one step of the evaluation method with basic assumptions of the physical camera model, a gamma correction common to cameras can be reversed to obtain a linearized RGB image from the RGB image of the respective camera. This step can be eliminated if the corresponding camera does not perform a gamma correction, so that the gamma correction does not have to be reversed afterwards. This can be the case, for example, if the gamma correction of the corresponding camera is disabled or if the camera does not perform gamma correction for other reasons.

In another step of the evaluation method, a pixel-by-pixel association of image areas with ground areas can be performed using the known height profile of the earth surface of the monitored area, for example. Each pixel can correspond to a square partial section of the monitored area.

Alternatively, the pixel-by-pixel association of image areas with ground areas can be taken over from cloud velocity ascertainment. Instead of a pixel-by-pixel association, other associations are also conceivable.

Geometric calibrations of the corresponding camera and transformations based thereon can be applied when associating the image areas with ground areas. Furthermore, an association without using calibrations is conceivable. The calibrations and transformations based thereon can be implemented as a machine-based learning model (machine learning model) and can be continuously improved.

In another step of the evaluation method, intensities of the color channels of the linearized RGB image can be weighted and summed. The weighting can achieve a sensitivity of the corresponding camera as uniformly as possible in the visible wavelength range.

In another step of the evaluation method, a multiplication with a broadband correction can take place, which takes into account the proportion of broadband solar radiation that originates from the non-visible wavelength range. In addition, a multiplication with a calibration factor which takes into account the sensitivity of the camera is conceivable.

In addition, it is possible to apply at least one correction to take into account interferences with the measurement, such as a lens refraction, image saturation, influence of the exposure control, of the corresponding camera. Additionally or alternatively, applied correction factors, such as broadband correction, the calibration factor, the correction of interferences, can be partially summarized or rewritten.

In addition, these corrections can be replaced or supplemented by statistically determined corrections, for example via machine learning, in particular based on image features.

In another step of the evaluation method, the radiation impinging on one plane and being reflected from the ground can also be ascertained for inclined planes and also for planes oriented towards the ground.

In an alternative embodiment of the method, the partial steps for ascertaining the radiation reflected from the ground, such as the application of a physical camera model and/or the assignment of image areas to sky areas and/or the application of physically motivated corrections and/or the projection to any plane can be partially or as a whole imitated by a machine-learning model.

In addition, in another step, the current albedo of the ground or a more detailed reflectance of the ground can be derived from the ascertained reflected radiation and the ascertained direct radiation and the ascertained diffuse radiation.

Advantageously, the evaluation of the camera data of the lower partial field of view of at least approximately 180° around the camera assembly or of the camera data associated with the earth surface and the upper partial field of view of at least approximately 180° around the camera assembly or camera data associated with the sky makes it possible to ascertain the current albedo or reflectance of the ground in the monitored area, for example due to weather, seasonal, or vegetation-related conditions. Therefore, resorting to a less accurate estimate of the albedo or reflectance of the ground, respectively, can be eliminated. This allows a better assessment of solar radiation in this area.

Advantageously, the reflectance or albedo of the ground and/or the reflected radiation and/or direct radiation and/or the diffuse radiation can be indicated in an angularly resolved and spectrally resolved manner.

In addition, the global and diffuse irradiance in any inclined plane can be calculated from the radiation from the different areas of the ground and from the angularly and spectrally resolved reflectance of the ground or albedo, respectively, including those planes that point to the ground. In this way, the radiation on the rear of the module can be calculated individually for each module for bifacial photovoltaic modules, and taking into account the typically complex geometry of the power plants. This setup can also be supported by combination with a pyranometer.

The reflectance corresponds to the reflection factor of the surface. The reflection factor indicates the ratio of a radiant power reflected from a surface to a radiant power impinging on the surface.

An angularly resolved reflectance is understood to mean information in the sense of a bidirectional reflectance distribution function or derived quantities such as a detailed composition of the albedo, in particular a black-sky albedo and white-sky albedo.

A spectrally resolved reflectance is the ratio of the radiant power reflected by a surface at a specific wavelength or wavelength range and the radiant power impinging on the surface at that particular wavelength or in that particular wavelength range.

In addition, camera data associated with the camera data of the lower field of view can advantageously be used to monitor pollution or damage to a photovoltaic system and other solar collectors to be able to arrange cleaning or repair, if necessary.

Advantageously, ascertainment of the direct radiation and/or the diffuse radiation together with the reflected radiation can be used to ascertain the performance of a solar plant at the location of the inventive assembly and to evaluate a solar resource at the location. No additional sensors or sensor units, such as pyranometers, are required. Radiation can be ascertained just by the at least one camera and its camera data.

According to a favorable embodiment of use of the assembly, a height of the clouds can be ascertained from the velocity of at least one cloud above the earth surface and the angular velocity of at least one cloud in the camera image.

The cloud velocity above the ground can be calculated in the upper partial field of view of at least approximately 180° around the camera assembly based on the angular velocity v_{pix/s}:

$${v}_{m / s} = {v}_{pixels / s} 2 tan θ {H}_{2} / N$$

The height H₂ of the cloud therefore is:

$${H}_{2} = \frac{{v}_{m / s} N}{{v}_{pixels / s} 2 tan θ}$$

The angle θ corresponds to the maximum zenith angle up to which the upper partial field of view of at least approximately 180° around the camera assembly is evaluated.

N corresponds to the diameter in pixels of the circular image area, which represents the sky area having a zenith angle less than or equal to θ.

The angle θ and the parameter N can be determined from the camera image of the upper partial field of view of at least approximately 180° around the camera assembly, v_{m/s} corresponds to the ascertained velocity of the cloud above the ground, and v_{pix/s} corresponds to the ascertained angular velocity of the cloud. H₂ corresponds to the height of the cloud projected over the camera assembly or above the at least one camera of the camera assembly oriented towards the sky. Since the distance of at least one camera to the ground is known, the known height profile of the monitored area, the current cloud position and the height of the cloud projected over the camera can be used to calculate the actual height of the cloud above the ground at its current position. Refinement of the calculations is possible.

In particular, a future cloud position can be ascertained using the height of the clouds, the current position of the clouds, and the cloud velocity above the earth surface. From this, a future shading or a future global irradiance can be estimated or calculated and thus predicted in a specified area. This allows more accurate shortest-term forecasts of solar radiation with only one camera assembly at the same location, wherein the cameras used are installed just a few meters above the ground. Advantageously, this allows an early reaction to shadings or a fluctuation in the performance of the solar system to be expected. The camera data can advantageously be ascertained at a common location, which makes it easier to maintain and operate the inventive assembly and makes it more cost-effective.

According to a favorable embodiment of the use of the assembly, the velocity of clouds above the earth surface and/or the angular velocity of clouds in the camera image can be extrapolated in time and/or space.

Here, both the angular velocity of clouds in the camera image and the velocity of clouds above the earth surface can be averaged and/or extrapolated in time and space to obtain greater temporal and spatial coverage. This also makes it possible to determine the cloud height and the cloud velocity of clouds whose shadows are not (yet) captured in the lower partial field of view of at least approximately 180° around the camera assembly. The temporal and spatial extrapolation can be used to compensate that the lower field of view covers a small portion and thus less cloud shadows than clouds captured in the upper partial field of view. Due to the temporal and spatial extrapolation, it is not necessary to use the data of one cloud and its shadow for evaluation. The shadows of other clouds can also be used to determine the cloud height of a cloud captured in the upper partial field of view of at least approximately 180° around the camera assembly. This evaluation is less accurate than if the camera data of a cloud and its shadow is used for evaluation. However, it is possible to ascertain the cloud height continuously. For known systems, such as lidar systems or ceilometer systems, cloud heights are only ascertained selectively.

According to a favorable embodiment of the use of the assembly, at least one current and/or future value of at least one component of the global irradiance can be determined in a spectrally and/or angularly resolved manner from the camera data and/or the ascertained parameters.

Angularly resolved radiation information, in particular the radiance, can be weighted and integrated into the plane of interest corresponding to a projection.

The angularly resolved information itself can be of interest to a user, so in that case the weighting and integration can be eliminated. Angularly resolved capture of at least one component of the global irradiance can determine the current and/or future albedo of the ground. Furthermore, a current and/or future irradiance of a radiation impinging on a plane with a known inclination to the ground, such as a rear of a bifacial photovoltaic module, can be determined in an advantageous manner. Additional support by a pyranometer or other suitable sensor is possible. Advantageously, no additional sensors such as pyranometers are required to resolve the irradiances of the components of global irradiance in a spectrally and/or angularly resolved manner, or to ascertain irradiances on planes inclined to the earth surface.

According to a favorable embodiment of the use of the arrangement, the at least one component of the global irradiance can be ascertained on an inclined surface, in particular on an arbitrarily oriented surface. This advantageously allows ascertaining an optimal angle of inclination of solar modules, including bifacial photovoltaic modules. Alternatively or additionally, a current and/or an expected performance can be ascertained if angles of inclination of solar modules, including bifacial photovoltaic modules, are known.

A method is proposed to determine at least one parameter to determine at least one component of a global irradiance, wherein camera data is collected at a common location in a field of view of at least approximately 360° around a camera assembly. Information concerning solar radiation and/or the position and/or properties of clouds is derived from the camera data.

In particular, the method can be a computer-implemented method.

Substantially the same definitions apply to the method for ascertaining at least one parameter for determining at least one component of a global irradiance as to the use of the assembly and the assembly for ascertaining at least one parameter for determining at least one component of a global irradiance.

Therefore, a repetition of the definition of, for example, the cloud features, the angularly resolved reflectance, and the spectrally resolved reflectance, is eliminated at this point.

Since the evaluation steps of the method substantially correspond to the evaluation steps of the application of the device, repetition is also eliminated in the following and the description of the use of the assembly is referred to for details of the method steps.

Further evaluation is also possible using the evaluation results having other time stamps or using evaluation results from another color channel. In this case, evaluation results of the upper partial field of view of at least approximately 180° around the camera assembly or from the camera data associated with the sky and the evaluation results of the lower partial field of view of at least approximately 180° around the camera assembly or from the camera data associated with the earth surface can be combined.

This will allow resorting of estimates or values from external sources to be advantageously eliminated for ascertaining most parameters for determining at least one component of a global irradiance, thereby making the ascertainment of the parameters for a specified location more accurate and reliable than using standard methods for capturing and/or forecasting at least one parameter for ascertaining and/or predicting at least one component of a global irradiance, which resort to estimates and values from external data sources.

Advantageously, by evaluating the field of view of at least approximately 360° around the camera assembly, the method allows the advantages of an assembly having a sky camera oriented toward the sky, also known as a cloud camera, to be combined with the advantages of an assembly having a ground camera oriented toward the ground, also known as a shadow camera, and the disadvantages of the sky camera and the cloud camera to be compensated.

To achieve the advantages, the camera data associated with the respective partial field of view is evaluated. In addition, the camera data of the respective partial fields of view are advantageously captured at a common location, in particular simultaneously.

Image features of one or more color channels of the respective partial field of view can be evaluated, resulting from clouds and cloud shadows and/or from radiation coming in at least one lens of at least one camera.

In addition, the intensity values of one or more color channels of the respective partial field of view can be evaluated. The evaluation results of individual color channels can be compared to evaluation results of other color channels or evaluation results with other time stamps.

By combining the advantages, a camera assembly having a spatial field of view of at least approximately 360° can be sufficient to capture sufficient camera data to reliably capture and/or predict desired parameters. This means that the evaluation of camera data from other cameras at other locations or the evaluation of measurement data from other sensor units can be eliminated, thereby reducing costs and reducing the time required to evaluate.

An advantage of the evaluation of the camera data of an upper partial field of view is that a large portion of the sky can be captured and monitored, in particular, clouds can be detected long before their shadows arrive in the monitored area, and corresponding predictions can be made.

An advantage of the evaluation of the camera data of the lower partial field of view or camera data associated with the earth surface is that some parameters, such as a cloud velocity above the ground, can be extracted precisely and directly from this camera data.

The monitorable and capturable portion of the ground depends, among other things, on a height at which the at least one camera which captures the lower partial field of view of is disposed.

Advantageously, a prediction can be ascertained using camera data from the upper partial field of view or from camera data associated with the sky, respectively, which does not necessarily require a large portion of the ground to monitor the ground, such that the camera assembly can be disposed at a lower height above the ground, in contrast to known shadow camera assemblies.

According to a favorable embodiment of the method, the field of view of the camera assembly at a specified location can be composed of a first partial field of view and a second partial field of view of at least approximately 180° each around the camera assembly. Camera data can be captured in a first partial field of view using at least one first camera and be captured in a second partial field of view using at least one second camera, wherein the two partial fields of view of the cameras complement each other to form a field of view of at least approximately 360°.

According to a favorable embodiment of the method, at least one first camera can capture camera data as a sky camera can capture camera data in the first partial field of view which is oriented towards the sky and forms an upper partial field of view. Camera data can be captured in the second partial field of view which is oriented towards the earth surface and forms a lower partial field of view, using the at least one second camera as a ground camera.

Alternatively, a 360° camera having a field of view of at least approximately 360° around the camera assembly can capture camera data in the first partial field of view and camera data KDE in the partial field of view. In particular, the first partial field of view can form an upper partial field of view oriented towards the sky, and the second partial field of view can form a lower partial field of view oriented towards the earth surface.

Advantageously in this case, the camera data of the respective cameras can be easily associated with the upper partial field of view or the lower partial field of view. Advantageously, the method can reduce an expense of purchasing and operating a hardware item, since the advantages of a cloud camera assembly and a shadow camera assembly can be combined.

According to a favorable embodiment of the method, camera data associated with the sky can be extracted from the captured camera data and at least one of the following parameters can be ascertained from these camera data associated with the sky: a direct radiation and/or a diffuse radiation and/or a global irradiance and/or at least a position of cloud features and/or cloud-covered areas of the sky and/or an angular velocity of at least one cloud in the camera image from cloud positions and/or from the position of cloud features in the camera image between at least two time stamps.

Advantageously, ascertainment of the direct radiation and/or the diffuse radiation can be used to ascertain the performance of a solar plant at the location of the inventive assembly and to evaluate a solar resource at the location.

The radiation can only be determined based on camera data, without additional measurement data from sensors.

Advantageously, knowledge of the sky areas covered by clouds in the upper partial field of view can be used for further assessment of the ascertained radiation. For example, diffuse radiation from clouds can increase, and direct radiation from clouds can decrease. Different radiation conditions can exist at the location in the case of a different weather.

Current and future radiation conditions can be ascertained at least partially by ascertaining cloud positions and the velocity of clouds.

For more details, reference is made to the use of the assembly for determining a parameter.

According to a favorable embodiment of the method, camera data associated with the earth surface can be extracted from the captured camera data and at least one of the following parameters can be ascertained from this camera data associated with the earth surface: a radiation reflected from the earth surface and/or an albedo of the earth surface and/or at least one cloud shadow position and/or a velocity of at least one cloud above the earth surface from the cloud shadow positions between at least two time stamps.

The velocity of a cloud or of multiple clouds above the ground can be ascertained in the inventive method from the camera images of the lower partial field of view or from the camera data associated with the earth surface, respectively.

The corresponding evaluation method is similar to the one used to determine the angular velocity of the clouds from images of the upper partial field of view or from the camera data associated with the sky, respectively.

In an alternative method, image features that correspond to the position of at least one cloud shadow and their shift Δm, Δn can also be ascertained by other means, for example using SIFT (scale invariant feature transform) or other machine learning methods.

For more details, reference is made to the use of the assembly for determining a parameter.

Advantageously, ascertainment of the direct radiation and/or the diffuse radiation together with the reflected radiation can be used to ascertain the performance of a solar plant at the location of the inventive assembly and to evaluate a solar resource at the location. No additional sensors or sensor units, such as pyranometers, are required. Radiation can be ascertained just by the at least one camera and its camera data.

According to a favorable embodiment of the method, a height of the clouds can be ascertained from the velocity of at least one cloud above the earth surface and the angular velocity of at least one cloud in the camera image.

For more details, reference is made to the use of the assembly for determining a parameter.

In particular, a future cloud position can be ascertained using the height of the clouds, the current position of the clouds, and the cloud velocity above the earth surface. From this, a future shading or a future global irradiance can be estimated or calculated in a specified area. This allows more accurate shortest-term forecasts of solar radiation with only one camera assembly at the same location, wherein the cameras used are installed just a few meters above the ground. Advantageously, this allows an early reaction to shadings or a fluctuation in the performance of the solar system to be expected.

According to a favorable embodiment of the method, the velocity of clouds above the earth surface and/or the angular velocity of clouds in the camera image can be extrapolated in time and space.

Here, both the angular velocity of clouds in the camera image and the velocity of clouds above the earth surface can be averaged and/or extrapolated in time and space to obtain greater temporal and spatial coverage. This also makes it possible to determine the cloud height and the cloud velocity of clouds whose shadows are not (yet) captured in the lower field of view.

The temporal and spatial extrapolation can be used to compensate that the lower field of view covers a smaller portion and thus less cloud shadows than clouds captured in the upper partial field of view.

Due to the temporal and spatial extrapolation, it is not necessary to use the data of one cloud and its shadow for evaluation. The shadows of other clouds can also be used to determine the cloud height of a cloud captured in the upper partial field of view. This evaluation is less accurate than if the camera data of a cloud and its shadow is used for evaluation. However, it is possible to ascertain the cloud height continuously.

According to a favorable embodiment of the method, at least one current and/or future value of at least one component of the global irradiance can be determined in a spectrally and/or angularly resolved manner from the camera data and/or the ascertained parameters.

Angularly resolved radiation information, in particular the radiance, can be weighted and integrated into the plane of interest corresponding to a projection.

The angularly resolved information itself can be of interest to a user, so in that case the weighting and integration can be eliminated. Angularly resolved capuring of at least one component of global radiation can determine the current and/or future albedo of the ground. Furthermore, a current and/or future irradiance of a radiation impinging on a plane with a known inclination to the ground, such as a rear of a bifacial photovoltaic module, can be determined in an advantageous manner. Additional support by a pyranometer or other suitable sensor is possible.

Advantageously, no additional sensors such as pyranometers are required to resolve the irradiances of the components of global radiation in a spectrally and/or angularly resolved manner, or to ascertain irradiances on planes inclined to the earth surface.

According to a favorable embodiment of the method, at least one component of the global irradiance can be ascertained on an inclined surface. This advantageously allows ascertaining an optimal angle of inclination of solar modules, including bifacial photovoltaic modules. Alternatively or additionally, if angles of inclination of solar modules are known, a current and/or an expected performance of bifacial photovoltaic modules, among other things, can be ascertained.

The inventive assembly, the inventive use of the assembly, and the inventive method can be used to predict global radiance and/or to predict components of the global radiance at specific earth surface areas due to cloud position and the inclination of the surface onto which the global radiance will impinge. This enables inventive assembly, the inventive use of the assembly, and the inventive method to be used to make shortest-term forecasts of the solar radiation.

These predictions have been used to run self-sufficient microgrids more efficiently through targeted control of memories or generators. In addition, such predictions can support the operation of distribution networks and the marketing the output of solar power plants.

Furthermore, the accurate and angularly resolved measurement of the radiation reflected from the ground and the radiation from the sky can improve the monitoring of photovoltaic power plants. This will allow bifacial power plants in particular to be monitored more efficiently and with less effort and in an automated form.

By monitoring cloud coverage, the inventive assembly, the inventive use of the assembly, and the inventive method can also provide input data for numerical weather models or for combined forecast models incorporating satellite data and can therefore be of interest to private and public weather services. The inventive assembly, the inventive use of the assembly, and the inventive method can also contribute to more cost-effective and complete monitoring of the airspace, e.g. above an airport, by monitoring the cloud coverage and the height of clouds.

In addition, a computer program or computer program product is proposed, comprising commands that cause an inventive device to perform an inventive method for ascertaining at least one parameter for determining at least one component of a global irradiance GI.

In addition, a computer program or computer program product is proposed, comprising commands that, when the computer program is run by a computer, cause the computer to perform a method for ascertaining at least one parameter for determining at least one component of a global irradiance GI, comprising capturing of camera data KDH, KDE from a camera assembly in a field of view at least approximately spherical around the camera assembly, derive information concerning solar radiation and/or the position and/or properties of clouds from the camera data KDH, KDE.

### BRIEF DESCRIPTION OF THE DRAWINGS

Further advantages will be apparent from the following description of the drawings. Exemplary embodiments of the invention are shown in the figures. The figures, the description, and the claims contain numerous features in combination. A person skilled in the art will expediently also consider the features individually and combine them into further meaningful combinations.

The figures exemplify the following:

FIG. 1 shows a schematic representation of an assembly for capturing and/or predicting at least one parameter for determining and/or predicting at least one component of a global irradiance;

FIG. 2 shows a schematic representation of an assembly for capturing and/or predicting at least one parameter for the determing and/or predicting at least one component of a global irradiance;

FIG. 3 a schematic representation of a use of an assembly from FIG. 1 or FIG. 2 and a schematic representation of a method for capturing and/or predicting at least one parameter for determining and/or predicting at least one component of a global irradiance.

### DETAILED DESCRIPTION

In the figures, identical or identically acting components are identified by the same reference numerals. The figures only show examples and are not to be understood as restrictive. Directional terminology used in the following with terms such as “left”, “right”, “above”, “below”, “in front of”, “behind”, “after”, and the like only serves for better comprehension of the figures and is in no way intended to restrict the generality. The components and elements shown, their configuration and use can vary according to the considerations of a person skilled in the art and can be adapted to the respective applications.

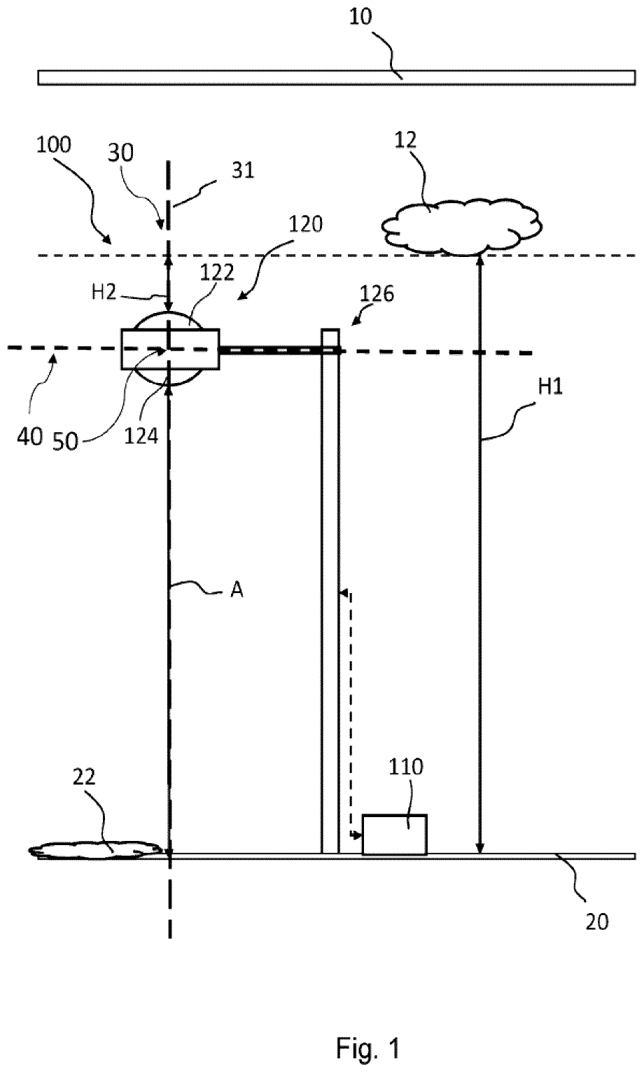

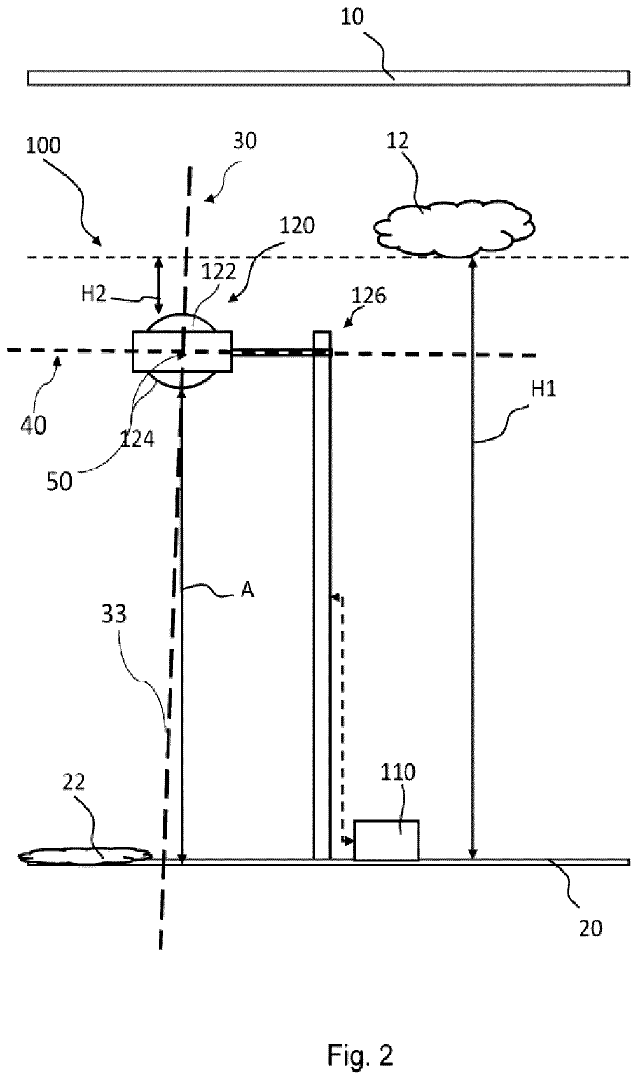

FIGS. 1 and 2 show, in schematic representation, an inventive assembly 100 for capturing and/or predicting at least one parameter for the determining and/or predicting at least one component of a global irradiance GI.

The assembly 100 comprises at least one evaluation and control device 110 and a camera assembly 120 with at least one camera 122, 124 and a holding assembly 126.

In the illustrated exemplary embodiment, the assembly 100 comprises a single evaluation and control device 110. In an alternative exemplary embodiment not illustrated, the assembly 100 can have more than one evaluation and control device 110. The evaluation and control device 110 is wirelessly connected to the existing cameras 122, 124 in the illustrated exemplary embodiment of the assembly 100. A data connection via a cable is also conceivable.

In this example, the assembly 100 has a common axis 30 and a horizontal axis 40. The camera assembly 120 is disposed along the common axis 30. The camera assembly 120 has a center 50, which is disposed on the common axis 30. The common axis 30 is substantially oriented vertically and forms a substantially vertical axis 31 (FIG. 1) or tilted towards the vertical direction at a tilt angle and forms an oblique axis 33 (FIG. 2).

In the exemplary embodiment illustrated, the assembly 100 comprises two cameras 122, 124, which are installed at the same location in opposite orientation. The two cameras 122, 124 are disposed on the common axis 30, the substantially vertical axis 31 or the oblique axis 33. Thus the camera 122 and the camera 124 have the common axis 30 as a common axis 30, the substantially vertical axis 31 or the oblique axis 33. In an alternative exemplary embodiment not illustrated, the assembly 100 can have more than two cameras 122, 124 at the same location or have only one camera 122, 124. The one camera 122, 124 has two sensors (not illustrated). The sensors are disposed along the common axis 30.

The sensors point in opposite directions along the common axis 30, wherein a first sensor points up and a second sensor points down on the common axis 30, which is substantially vertical or oblique.

It is understood that the cameras 122 and 124 can be disposed on two axes instead of along a common axis 30, which two axes are extending substantially parallel to one another at a small distance, in particular at a distance of not more than about 10 m.

The spatial field of view of at least approximately 360° around the camera assembly 120 is conveniently composed of a first partial spatial field of view and a second partial spatial field of view of at least approximately 180° each around the camera assembly 120, which partial fields of view are disposed along the common axis 30. In particular, the common axis 30 is oriented substantially in a vertical direction 31 and forms the vertical axis 31, or is oriented at a tilt angle towards the vertical direction 31 and forms the oblique axis 33.

In an exemplary embodiment not illustrated, the assembly can have two axes, wherein one of the cameras 122, 124 is disposed on one axis and the other of the cameras 122, 124 is disposed on the other axis, wherein the partial fields of view are disposed along the two axes, wherein the two axes are substantially disposed in parallel and at a small distance, in particular at a distance of not more than about 10 m.

The holding assembly 126 fixes the two cameras 122, 124 at a specified distance A to an earth surface 20. In the exemplary embodiment illustrated, the holding assembly 126 is L-shaped, but other designs are also possible. For example, a drone that holds the cameras is conceivable. The holding assembly fixes the camera 122, 124 such that the cameras 122, 124 are arranged along the common axis 30.

The camera assembly 120 is designed to capture camera data KDH, KDE in a spatial field of view of at least approximately 360° around the camera assembly 120. The spatial field of view of at least approximately 360° extends along the common, substantially vertical axis 31 or oblique axis 33 and has two fields of vision oriented in opposite directions along the common axis 30. A first field of view is facing up and the second field of view is facing down along the common axis 30.

The camera data KDH, KDE is suitable for deriving information concerning solar radiation and/or the position WP and/or properties of clouds 12. The field of view of the camera assembly 120 in a specified location is composed in the shown example of an upper partial field of view orientated towards the sky 10 of at least approximately 180° around the camera assembly and a lower field of view orientated towards the earth surface 20 of at least approximately 180° around the camera assembly 120. More than two partial fields of view are conceivable as well. In addition, a different orientation of the partial fields of view can be implemented.

A field of view of at least approximately 360° around the camera assembly 120 is understood to be an at least approximately spherical field of view around a center 50. The two cameras 122, 124 are disposed at this center 50. The two cameras 122, 124 are disposed here along the common axis 30, wherein the common axis is substantially vertically oriented and can form a substantially vertical axis or can be tilted to the vertical axis at a tilt angle and forms an oblique axis. The center 50 is composed of an intersection of the common axis 30 and the horizontal axis 40.

The at least one camera 122, 124 can be understood as an RGB camera or an infrared camera. In the illustrated exemplary embodiment of the assembly 100, the cameras 122, 124 are designed as RGB cameras with fish eye lenses. In an alternative exemplary embodiment not illustrated, other setups with parabolic mirrors are conceivable instead of cameras with fish-eye lenses.

For example, the camera 122, 124 can record 24 frames per second, wherein these can be provided with a corresponding time stamp. Other image generation rates can also be selected. In addition, extended setups with, for example, shading devices are conceivable to reduce an interference effect of direct sunlight.

In the exemplary embodiment illustrated, the assembly 100 comprises at least a sky camera 122, which captures camera data KDH in the upper partial field of view of at least approximately 180° around the camera assembly 120, which is associated with the sky.

In addition, the assembly 100 in the exemplary embodiment illustrated comprises at least one ground camera 124, which captures camera data KDE in the lower field of view of at least approximately 180° around the camera assembly 120, which is associated with the earth surface 20. The upper partial field of view and the lower partial field of view extend along the common axis 30.

In the exemplary embodiment of the assembly 100 illustrated, the evaluation and control device 110 ascertains at least one of the following parameters from the captured camera data KDH of the upper partial field of view of at least approximately 180° around the camera:
(i) a direct radiation DNI; and/or
(ii) a diffuse radiation diffI; and/or
(iii) a global irradiance GI; and/or
(iv) at least one position WP of cloud features 12; and/or
(v) sky areas covered by clouds 12; and/or
(vi) from cloud positions WP and/or from the position of cloud features 12 in the camera image between at least two time stamps, an angular velocity Wpwvs of at least one cloud 12 in the camera image.

Cloud features are image features of the images taken, which can be associated with a cloud 12 and/or a cloud formation.

In the exemplary embodiment of the assembly 100 illustrated, the evaluation and control device 110 ascertains at least one of the following parameters from the captured camera data KDE of the lower partial field of view of at least approximately 180° around the camera assembly:
(i) an ERS radiation reflected from the earth surface of 20; and/or
(ii) an albedo AL of the earth surface 20; and/or
(iii) at least one cloud shadow position SP; and/or
(iv) from cloud shadow positions SP between at least two time stamps, a velocity v_{m/s} of at least one cloud 12 above the earth surface 20.

In the exemplary embodiment of the assembly 100 illustrated, the evaluation and control device 110 ascertains the radiation from each area of the spatial field of view of at least approximately 360° from the intensity values I of the RGB channels in the camera images.

Based on this, the albedo AL of the ground 20 or a more detailed reflectance of the ground 20 is derived.

To determine the velocities v_{m/s}, v_{pix/s} of clouds 12 and cloud shadows 22, respectively, the corresponding camera 122, 124 captures image sequences at short intervals as camera data KDH, KDE. The image sequences determine the shift of image features between the capture times. From this, the movement of a cloud 12 in the sky 10 can be ascertained. At the same time, the movement of the corresponding cloud shadow 22 on the ground 20 can be determined. Due to the known time interval between the images, this movement can be converted into a velocity v_{m/s} of the cloud 12 above the earth surface 20 and an angular velocity v_{pix/s} of clouds 12 in the camera image.

In the exemplary embodiment of the assembly 100 illustrated, the at least one evaluation and control device 110 ascertains a height H1, H2 of clouds 12 from the velocity v_{m/s} of at least one cloud 12 above the earth surface 20 and the angular velocity v_{pix/s} of at least one cloud 12 in the camera image.

H1 corresponds to the distance between the cloud 12 and the opposing ground 20.

H2 corresponds to the distance between the camera 122 oriented upwards and a height of cloud 12 projected over the camera 122 oriented upwards. H2 can be determined from the velocity of the clouds v, H1 can be determined from the known distance A of the camera 122, 124 to the ground 20 and a known height profile of the area to be monitored.

The evaluation and control device 110 ascertains a future cloud position WP and a future shading or global irradiance GI of a specified horizontal or inclined area using the height H1, H2 of the clouds 12 and the cloud velocity v_{m/s} above the earth surface 20.

In the exemplary embodiment illustrated, at least one evaluation and control device 110 extrapolates the velocity v_{m/s} of clouds 12 above the earth surface 20 and the angular velocity v_{pix/s} of clouds 12 in the camera image in time and space. In an alternative exemplary embodiment not illustrated, only velocities v_{m/s}, v_{pix/s} of clouds 12 can be captured whose cloud shadow 22 is measured from the lower partial field of view of at least approximately 180° around the camera assembly.

In the exemplary embodiment of the assembly 100 illustrated, the at least one evaluation and control device 110 ascertains at least a current and/or future value of at least one component of the global irradiation intensity GI in a spectrally and/or angularly resolved manner from the camera data KDH, KDE and/or the ascertained parameters.

In the exemplary embodiment of the assembly 100 illustrated, at least one evaluation and control device 110 ascertains at least one component of the global irradiance GI on an inclined surface.

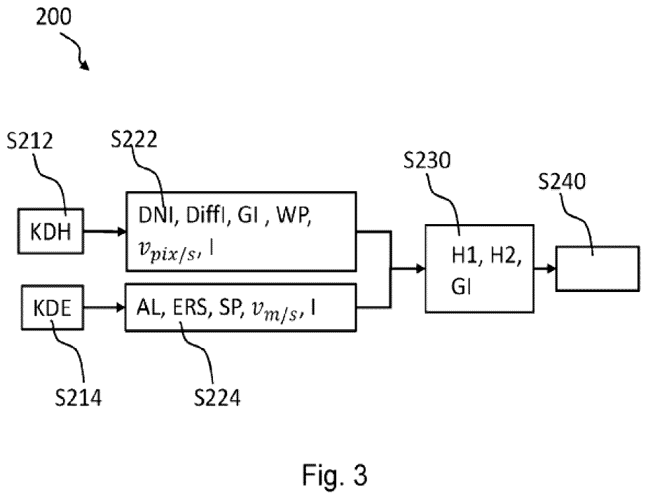

FIG. 3 shows a schematic representation of a use of an assembly from FIG. 1 or FIG. 2 and a schematic representation of a method 200 for capturing and/or predicting at least one parameter for determining and/or predicting at least one component of a global irradiance GI.

In the method steps S212 and S214, camera data KDH, KDE are captured at a common location in a spatial field of view of at least approximately 360° around a camera assembly 120. Information concerning solar radiation and/or the position WP and/or properties of clouds 12 is derived from the camera data KDH, KDE.

In the exemplary embodiment described, the spatial field of view of at least approximately 360° around the camera assembly is composed of an upper partial field of view oriented towards the sky 10 of at least approximately 180° around the camera assembly 120 and a lower partial field of view oriented towards the earth surface 20 of at least approximately 180° around the camera assembly 120.

In method step S212, camera data KDH is captured with at least one sky camera 122 in an upper partial field of view of at least approximately 180° around the camera assembly that is associated with a sky 10. In method step S214, camera data KDE is captured with at least one ground camera 124 in a lower field of view of at least approximately 180° around the camera assembly that is associated with an earth surface 20. The method steps S212 and S214 can be executed simultaneously or at offset times. In an alternative method step, camera data KDE, KDH can first be associated with the earth surface and the sky 10. This step is eliminated in the exemplary embodiment illustrated because the upper field of view and the lower field of view allow a clear association of the camera data.

In method step S222, the following are ascertained from the captured camera data KDH of the upper field of view of at least approximately 180° around the camera assembly:
(i) a direct radiation DNI; and/or
(ii) a diffuse radiation DiffI; and/or
(iii) a global irradiance GI; and/or
(iv) sky areas covered by clouds; and/or
(v) at least one cloud position WP; and/or
(vi) from cloud positions WP and/or from the position of two time stamps, an angular velocity of clouds 12 in the camera image.

In method step S224, the following are ascertained from the captured camera data KDE of the lower field of view of at least approximately 180° around the camera assembly:
(i) an ERS radiation reflected from the earth surface of 20; and/or
(ii) an albedo AL of the earth surface 20; and/or
(iii) at least one cloud shadow position SP; and/or
(iv) from cloud shadow positions SP between at least two time stamps, a velocity v_{m/s} of at least one cloud 12 above the earth surface 20.

For ascertaining the direct radiation DNI and/or the diffuse radiation DiffI and/or the radiation ERS reflected from the earth surface 20, intensity values I of at least one color channel of the corresponding camera 122, 124 are evaluated.

In method step S230, the global irradiance GI is calculated from the components DiffI, DNI, ERS of the global irradiance GI, as ascertained in method steps S222 and S224. Also, at least one component DiffI, DNI, ERS of the global irradiance GI can be ascertained on a surface inclined towards the earth surface 20.

In method step S230, a height H1, H2 of the clouds 12 is ascertained from the velocity v_{m/s} of at least one cloud 12 above the earth surface 20 and the angular velocity v_{pix/s} of at least one cloud 12 in the camera image.

In this context, the velocity v_{m/s} of clouds 12 above the earth surface 20 and the angular velocity v_{pix/s} of clouds 12 in the camera image can be extrapolated in time and space.

In method step S240, a future cloud position WP can be ascertained and a future shading and/or the future global irradiance GI of a specified area can be ascertained as a forecast using the height H1, H2 of clouds 12 and the cloud velocity v_{m/s} above the earth surface 20.

The current and/or future values of the components DiffI, DNI, ERS of the global irradiance GI ascertained in method steps S222 and S224 can be ascertained from the camera data KDH, KDE and/or the ascertained parameters at least in a spectrally and/or angularly resolved manner.

The method 200 is executed in a computer program which comprises commands that causes an assembly 100 to perform a method for ascertaining at least one parameter for determining at least one component of a global irradiance GI. The computer program can be part of a computer program product.

The computer program or computer programme product comprise commands that, when a computer executes the computer program, cause it to perform the method 200 for ascertaining at least one parameter for determining at least one component of a global irradiance GI, wherein the following steps are performed:
capturing camera data KDH, KDE from a camera assembly 120 in a spherical field of view around the camera assembly 120,
deriving information concerning solar radiation and/or position (WP) and/or properties of clouds 12 from the camera data KDH, KDE.

### LIST OF REFERENCE SYMBOLS

10 sky
12 cloud
20 earth surface
22 shadow of the cloud
30 common axis
31 vertical direction, vertical axis
33 oblique axis
40 horizontal axis
50 center of the camera assembly
100 assembly
110 evaluation and control devices
120 camera assembly
122 sky camera
124 ground camera
126 holding assembly
200 method
S212-S240 method steps
KDH, KDE camera data
WP cloud position
SP cloud shadow position
v_{pix/s} angular velocity
v_{m/s} velocity above the ground
I intensity of a color channel
H1 height of the cloud from the earth surface
H2 height of the cloud from the highest point of the camera assembly
A distance of the camera assembly to the earth surface
GI global irradiance
DiffI diffuse radiation
DNI direct radiation
ERS radiation reflected from the earth surface

1. An assembly for ascertaining at least one parameter for determining at least one component of a global irradiance, comprising an evaluation and control device and a camera assembly having at least one camera, wherein the at least one camera is fixed at a predefined distance from an earth surface at least while ascertaining the parameter,
wherein the camera assembly is designed to capture camera data in a spatial field of view of at least approximately 360° around the camera assembly, wherein the camera data is suitable for deriving information concerning solar radiation and/or the position and/or properties of clouds.

2. The assembly of claim 1,
wherein at least one first camera captures camera data in a first partial field of view and at least one second camera captures camera data in a second partial field of view, wherein the two partial fields of view of the cameras complement each other to form a field of view of at least approximately 360°.

3. The assembly of claim 1, wherein the field of view of at least approximately 360° around the camera assembly is composed of the first partial spatial field of view and the second partial spatial field of view of at least approximately 180° each around the camera assembly, wherein the partial fields of view are arranged on top of one another.

4. The assembly of claim 1, wherein the evaluation and control device takes camera data associated with the sky from the captured camera data and, from this camera data associated with the sky ascertains at least one of the following parameters:
(i) a direct radiation; and/or
(ii) a diffuse radiation; and/or
(iii) a global irradiance; and/or
(iv) at least one position of cloud properties; and/or
(v) sky areas covered by clouds and/or
(vi) from cloud positions and/or from the position of cloud properties in the camera image between at least two time stamps, an angular velocity v_{pix/s} of at least one cloud in the camera image.

5. The assembly of claim 1, wherein the evaluation and control device takes camera data associated with the earth surface from the captured camera data and, from this camera data associated with the earth surface ascertains at least one of the following parameters:
(i) a radiation reflected at the earth surface; and/or
(ii) an albedo of the earth surface; and/or
(iii) at least one cloud shadow position; and/or
(iv) from the cloud shadow positions between at least two time stamps, a velocity v_{m/s} of at least one cloud above the earth surface.

6. The assembly of claim 4, wherein the evaluation and control device ascertains a height of the clouds from the velocity v_{m/s} of at least one cloud above the earth surface and the angular velocity v_{pix/s} of at least one cloud in the camera image.

7. The assembly of claim 4, wherein the at least one evaluation and control device extrapolates the velocity v_{m/s} of clouds above the earth surface and/or the angular velocity v_{pix/s} of clouds in the camera image in time and space.

8. The assembly of claim 4, wherein the at least one evaluation and control device determines an actual and/or future value of at least one component of the global irradiance in a spectrally or angularly resolved manner from the camera data and/or the ascertained parameters.

9. The assembly of claim 8, wherein at least one evaluation and control device determines at least one component of the global irradiance on an inclined surface.

10. A method of ascertaining at least one parameter for determining at least one component of a global irradiance, using an assembly comprising an evaluation and control device and a camera assembly having at least one camera, wherein the at least one camera is fixed at a predefined distance from an earth surface at least while ascertaining the parameter, and wherein the camera assembly is designed to capture camera data in a spatial field of view of at least approximately 360° around the camera assembly, wherein the camera data is suitable for deriving information concerning solar radiation and/or the position and/or properties of clouds, comprising recording camera data KDE is recorded in a spatial field of view of at least approximately 360° around the camera assembly,
deriving information concerning solar radiation and/or position and/or properties of clouds is derived from the camera data.

11. The method of claim 10,
comprising capturing camera data in a first partial field of view using at least one first camera and capturing camera data in a second partial field of view using at least one second camera, wherein the two partial fields of view of the cameras complement each other to form a field of view of at least approximately 360°.

12. The method of claim 10, wherein the field of view of at least approximately 360° around the camera assembly is composed of the first partial spatial field of view and the second partial spatial field of view of at least approximately 180° each around the camera assembly, wherein the partial fields of view are arranged on top of one another.

13. The method of claim 10, wherein camera data associated with the sky is taken from the captured camera data, and at least one of the following parameters is ascertained from these camera data associated with the sky:
(i) a direct radiation; and/or
(ii) a diffuse radiation; and/or
(iii) a global irradiance; and/or
(iv) at least one position of cloud properties; and/or
(v) sky areas covered by clouds; and/or
(vi) from cloud positions and/or from the position of cloud properties in the camera image between at least two time stamps, an angular velocity v_{pix/s} of at least one cloud in the camera image.

14. The method of claim 10, wherein camera data associated with the earth surface is taken from the captured camera data, and at least one of the following parameters is ascertained from these camera data associated with the earth surface
(i) a radiation reflected at the earth surface; and/or
(ii) an albedo of the earth surface; and/or
(iii) at least one cloud shadow position; and/or
(iv) from the cloud shadow positions between at least two time stamps, a velocity v_{m/s} of at least one cloud above the earth surface.

15. The method of claim 14, wherein a height of the clouds is ascertained from the velocity v_{m/s} of at least one cloud above the earth surface and the angular velocity v_{pix/s} of at least one cloud in the camera image.

16. The method of claim 14, wherein the velocity v_{m/s} of clouds above the earth surface and/or the angular velocity v_{pix/s} of clouds in the camera image are extrapolated in time and space.

17. The method of claim 10, wherein at least one current and/or future value of at least one component of the global irradiance is determined in a spectrally and/or angularly resolved manner from the camera data, and/or the ascertained parameters.

18. The method of claim 17, wherein at least one component of the global irradiance is determined on an inclined surface.

19. A a computer-implemented method for ascertaining at least one parameter for determining at least one component of a global irradiance, comprising collecting camera data at a common location in a spatial field of view of at least approximately 360° around a camera assembly, and
deriving information concerning solar radiation and/or position and/or properties of clouds from the camera data.

20. The method of claim 19,
comprising capturing camera data in a first partial field of view using at least one first camera and capturing camera data in a second partial field of view using at least one second camera, wherein the two partial fields of view of the cameras complement each other to form a field of view of at least approximately 360°.

21. The method of claim 19, wherein the field of view of at least approximately 360° around the camera assembly is composed of the first partial spatial field of view and the second partial spatial field of view of at least approximately 180° each around the camera assembly, wherein the partial fields of view are arranged on top of one another.

22. The method of claim 19, wherein camera data associated with the sky is taken from the captured camera data, and at least one of the following parameters is ascertained from these camera data associated with the sky
(i) a direct radiation; and/or
(ii) a diffuse radiation; and/or
(iii) a global irradiance; and/or
(iv) sky areas covered by clouds; and/or
(v) at least one cloud position; and/or
(vi) from cloud positions and/or from the position of cloud properties in the camera image between at least two time stamps, an angular velocity v_{pix/s} of at least one cloud in the camera image.

23. The method of claim 19, wherein camera data associated with the earth surface is taken from the captured camera data, and at least one of the following parameters is ascertained from these camera data associated with the earth surface:
(i) a radiation reflected at the earth surface; and/or
(ii) an albedo of the earth surface; and/or
(iii) at least one cloud shadow position; and/or
(iv) from the cloud shadow positions SP between at least two time stamps, a velocity v_{m/s} of at least one cloud above the earth surface.

24. The method of claim 23, wherein a height of the clouds is ascertained from the velocity v_{m/s} of at least one cloud above the earth surface and the angular velocity v_{pix/s} of at least one cloud in the camera image, in particular wherein a future cloud position is ascertained using the height of the clouds and the cloud velocity v_{m/s} above the earth surface and a future shading and/or a future global irradiance of a specified area is ascertained therefrom.

25. The method of claim 23, wherein the velocity v_{m/s} of clouds above the earth surface and/or the angular velocity v_{pix/s} of clouds in the camera image are extrapolated in time and space.

26. The method of claim 19 wherein at least one current and/or future value of at least one component of the global irradiance is ascertained in a spectrally and/or angularly resolved manner from the camera data, and/or the ascertained parameters.

27. The method of claim 26, wherein at least one component of the global irradiance is ascertained on an inclined surface.

28. A computer program or computer program product, comprising commands that cause an assembly comprising an evaluation and control device and a camera assembly having at least one camera, wherein the at least one camera is fixed at a predefined distance from an earth surface at least while ascertaining the parameter, and wherein the camera assembly is designed to capture camera data in a spatial field of view of at least approximately 360° around the camera assembly, wherein the camera data is suitable for deriving information concerning solar radiation and/or the position and/or properties of clouds to perform a method for ascertaining at least one parameter for determining at least one component of a global irradiance comprising collecting camera data at a common location in a spatial field of view of at least approximately 360° around a camera assembly, and deriving information concerning solar radiation and/or position and/or properties of clouds from the camera data.

29. A computer program product, comprising a computer program comprising commands that, when the computer program is executed by a computer, cause the computer to perform a method for ascertaining at least one parameter for determining at least one component of a global irradiance, comprising
capturing of camera data by a camera assembly in a spherical field of view around the camera assembly, and
deriving information concerning solar radiation and/or position and/or properties of clouds from the camera data.
